(19) United States
(12) Patent Application Publication
(10) Pub. No.: US 2007/0157880 A1
(43) Pub. Date: Jul. 12, 2007

(54) Immobilizing method, immobilization apparatus, and microstructure manufacturing method

(75) Inventors: Akihiko Tanioka, Tokyo (JP); Yutaka Yamagata, Wako City (JP); Kozo Inoue, Tokyo (JP)

Correspondence Address: OLIFF & BERRIDGE, PLC, P.O. BOX 19928, ALEXANDRIA, VA, 22320, US

(73) Assignees: AKIHIKO TANIOKA, Tokyo (JP); RIKEN, Wako-shi (JP); FUENCE CO., LTD., Tokyo (JP)

(21) Appl. No.: 10/546,008

(22) PCT Filed: Feb. 19, 2004
(86) PCT No.: PCT/JP04/01945

§ 371 Date: Jun. 26, 2006

(30) Foreign Application Priority Data
Feb. 19, 2003 (JP) 2003-040642

(51) Int. Cl. B05C 5/02

(52) U.S. Cl. 118/621; 239/690; 239/3; 118/300

(57) ABSTRACT

An immobilization method, an apparatus, and a manufacturing method of a microstructure are provided, where the method including the electrospray step by which a solution containing at least one objective substance is supplied to a capillary; and immobilization step by which the objective substance in the solution atomized in the electrospray step is immobilized on an object, which is to be coated and has an arbitrary shape, in a dried state by an electrostatic force while retaining functionality and/or activity of the objective substance, resulting in a thickness on the order of nanometers.

### FIELD OF THE INVENTION

The present invention relates to an immobilization apparatus and a method for immobilizing an objective substance while retaining the functionality and/or activity thereof by use of an electrospray device, and, in particular, to an immobilization apparatus and a method for immobilizing the objective substance on a substrate having an arbitrary shape (i.e., any configuration), such as a fine particle, a globular substance, or a film, as well as on a flat substrate, in the order of nanometers, and to a method of manufacturing a microstructure on the order of nanometers in size.

### RELATED ART STATEMENTS

Conventionally, various thin-film fabrication methods have been developed as technologies for immobilizing various kinds of materials. For instance, the conventional spin coating method is to form a uniform thin film of organic or inorganic material by dropping a solution onto a substrate being rotated, spreading the solution with a centrifugal force, vaporizing a volatile ingredient.

In addition, the conventional dip coating method is to form a thin film by dipping an objective substance into a coating solution, pulling the substrate upward, and drying a liquid film attached on the substrate.

However, the both the spin coating method and the dip coating method requires heating for drying off. In many cases, the functionality and activity of the objective substance may be lost or damaged by heat in the heating process. Furthermore, among biopolymers or the like, many of them may immediately lose their activities in natural drying because of time-consuming drying. Besides, even though the use of a volatile material in a solvent will principally eliminate the use of heating and may accelerate drying, there is almost no solvent having enough volatility and preventing the functionality and activity of various kinds of an objective substance from damaging or loosing it. In particular, it is believed that there is no solvent having such properties, which can be used for biopolymers. Therefore, these conventional technologies are impossible to immobilize various objective substances while retaining their functionalities and activities. More, these conventional technologies assume the use of flat substrates as members on which thin films are formed, so that they may be inappropriate for the purpose of forming thin films on the surfaces of objects, having other shapes, to be coated.

A spotting or coating device is a metallic chip capable of holding a liquid in a minute gap formed like a nib of a fountain pen or a device capable of applying a liquid on a substrate and drying the liquid to form a thin film. However, because of taking much time to drying, this kind of the device is also difficult to form a think film of biopolymer or the like which tends to easily lost its activity.

An inkjet method is a method of forming a thin film by ejecting minute droplets of a solvent, in which an objective functional polymer or the like is dissolved, from nozzles to attach them on a substrate and then drying. However, because of the above reason, i.e., taking much time to drying, this method is also difficult in formation of a thin film by immobilization of a functional polymer or the like while retaining the activity thereof.

Alternatively, there are other conventional methods for forming thin films of polymers and so on, such as evaporation methods including a thermal evaporation, laser evaporation, ionization evaporation, and electron beam. These conventional methods accumulate an objective polymer on a substrate by evaporation with heating or the like.

Because these evaporation methods accumulate an objective polymer on a substrate by evaporation with heating or the like, the objective substance tends to be thermally decomposed. Thus, the evaporation process destroys the functionalities and activities of most of polymers having high reactivities and biopolymers having biological activities. Therefore, the conventional evaporation method can only utilize just a very few kinds of polymer, including engineering plastics such as PPS, PE, and PVDF, which may remain stable when heated. Accordingly, the conventional evaporation method cannot immobilize various objective substances while retaining functionalities and activities.

Alternatively, as the conventional method of forming a thin film of polymer, there is a sputtering method. This conventional method forms a film by allowing accelerated ion particles to bump against an objective substance (target) to flick and attach the target molecule to a substrate by a kinetic energy due to the impact.

In this sputtering method, when the target molecule is flicked out by the collision of ion particles, a large change may occur in properties of the objective substance, for example, the main chain of the target substance (polymer) may be broken and radicals may be then generated or the radicals may be re-polymerized. In addition, similarly, when the target molecule is flicked out, the functions and biological activities of the objective substance may be unwillingly damaged. Furthermore, in this method, the objective substance is exposed to plasma or high heat under high vacuum, the functions and biological activities of the objective substance may often be destroyed. Therefore, in this conventional technique, the objective substance may hardly be immobilized while retaining various functions and activities thereof.

Alternatively, there are further other conventional methods including blade, pulling-up, and pressurized-spraying. However, these methods require heating or the like in the process of film formation, while uniform film cannot be formed. Besides, there is another problem that the film formation in the order of nanometers cannot be attained.

Moreover, there is a CVD method (chemical vapor deposition) as one of the conventional methods. This is a method for obtaining an objective substance by conducting some chemical reactions in gas phase (and after deposition). Thus, it cannot be applied in use of just immobilizing the objective substance without causing a chemical change.

For accumulating and immobilizing a biopolymer (e.g., protein) or a functional polymer as well as retaining the biological activity and functionality thereof, the formation of a thin film or the like requires to carry out immobilization under the conditions of preventing the substance from denaturing or deteriorating, but difficult to carry out using the conventional method or apparatus. One of the conditions, which makes the substance to be hardly denatured or deteriorated, is to very quickly drying a solution containing a biopolymer or the like. However, drying speed of normal liquid is limited at ambient temperature, and drying speed of liquid, which is spread on a substrate by coating or the like, is also limited even under vacuum. One method to dry the liquid quickly is to heat the solution containing an objective substance. In this case, most of the biopolymer or functional polymer may be denatured or deteriorated, so that a problem in which the biological activity or functionality may be diminished.

As another procedure for immobilizing a biopolymer or the like without denaturation, there is a lyophilization method. According to this method, however, the configuration of a thin film is hardly retained in freeze and typically comes powder.

Therefore, an electrospray deposition method (ESD method) has been developed as a technology for immobilizing a biopolymer while retaining the function and activity thereof (see, for example, Document 1: WO 98/58745 (pages 6-7, FIG. 1), Document 2: Japanese patent application laid open JP2001-281252A (paragraph Nos. 0008 to 0010, FIG. 2), and Document 3: Analytical Chemistry, vol. 71 (Morozoff et al., 1999, p 1415-1420, and p 3110-3117). The ESD method comprises applying high voltage on a sample solution containing a biopolymer or the like to carry out electrostatic atomization (electrospray) and accumulating the elctrostatically atomized biopolymer on a grounded substrate while retaining the function and activity of the biopolymer.

Furthermore, unlike the traditional ESD method, an apparatus and a method, by which a sample solution is supplied to a surface acoustic wave oscillator without using a capillary and then electrically charged to atomize from the surface of the element, thereby immobilizing the atomized sample solution on a substrate, have been developed in the art (see, for example, Document 4: the specification of Japanese Patent Application No. 2001-339593 (paragraph No. 0030, FIG. 1)).

Several conventional devices for realizing the EDS methods and the immobilization methods have been developed. The substrates (coated matters) of these conventional devices employ flat substrates made of metals or glass having at least slight electrical conductivity. For instance, in the documents described above, Document 1 (PCT WO 98/58745) and Document 2 (JP 2001-281252), or Document 3 (Analytical Chemistry vol. 71), methods and apparatuses for immobilizing biopolymers such as nucleic acids and proteins on substrates while retaining their biological activities in the shapes of films and spots, respectively, by means of electrospray (electrostatic atomization). Any of these ESD methods has an advantage of forming a thin film from a small quantity of the objective material. The conventional ESD method has intended to prepare a biopolymeric “thin film” having a thickness on the order of several microns while retaining its function and activity by immobilizing a biopolymer on a flat surface. Alternatively, the conventional ESD method has intended to prepare biopolymeric spots in an array arrangement, i.e., “microarray (DNA chip)” on a flat substrate by placing a mask device between an electrospray capillary and a target.

However, the application of a thin film or DNA chip prepared from an immobilized biopolymer by the conventional electrospray apparatus as described above is limited. Thus, the development of a method or apparatus for immobilizing an objective substance in any of various configurations or a method or apparatus for immobilizing an objective substance in the dry state on an object, which is to be coated and which has an arbitrary shape (i.e., in any of various configurations), so as to be of a desired thickness on the order of nanometers has been demanded.

### SUMMARY OF THE INVENTION

Therefore, an object of the present invention is to solve the above problems and to provide an immobilization method and an immobilization apparatus for immobilizing (i.e., depositing) an objective substance on an object, which is to be coated and which has an arbitrary shape (i.e., in any configuration), on the order of nanometers while retaining the functionality and/or activity of the objective substance. Here, the term “immobilization” means that, from an objective substance being dispersed and/or dissolved in a solvent, a thin film, a nonwoven fabric film, a three-dimensional microstructure, or the like is formed on an object to be coated in almost the dry state while being in a stable state, i.e., retaining the biological or functional activity thereof.

In other words, an immobilization method in accordance of an embodiment of the present invention, is characterized by comprising the step of:
carrying out electrospray such that a solution containing at least one objective substance is supplied into a capillary and an electric voltage is then applied on the solution to allow electrostatic atomization (i.e., spray) thereof, and
carrying out immobilization such that the objective substance in the solution atomized in the step of carrying out the electrospray is immobilized on an object, which is to be coated and has an arbitrary shape (i.e., in any configuration), in a dried state by an electrostatic force while retaining functionality and activity of the objective substance to form a dried microstructure having a thickness on the order of nanometers.

According to the present invention, it becomes possible to form a dried microstructure having a thickness on the order of nanometers by electrostatically immobilizing a any of various objective substances being dispersed or dissolved in a solution on an object, which is to be coated and has in an arbitrary shape (i.e., any configuration), in almost the dry state while retaining the functionality and/or activity of the objective substance.

Also, the immobilization method in accordance with the embodiment of the present invention further comprises the step of, before the step of carrying out electrospray, adjusting the average particle size of the objective substance contained in the solution.

For instance, the average particle size of the target substance may be adjusted by subjecting the solution to a centrifuge or by filtrating the solution through a filter (such as a nano-filter) to remove coarse particles to make the average particle size small, thereby making the formation of a thin film (i.e., thin layer) on the order of nanometers easier. Furthermore, the removal of coarse particles, the removal of impurities (contaminants), or reduction in average particle size may lead to eliminate clogging of a capillary nozzle. Moreover, it allows the use of a capillary having a more thinner nozzle diameter to form a thin film having a thinner minute structure.

In addition, an immobilization method in accordance with another embodiment of the present invention is characterized in that, before the step of carrying out electrospray, the solution is prepared by dissolving or dispersing an objective substance (solute) having a predetermined average molecular weight.

According to the present invention, depending on the characteristics of an objective substance or the desired thickness thereon on the order of nanometers, the average molecular weight of the objective substance used is prepared to form a structure having a desired thickness and a desired microstructure can be formed.

Furthermore, an immobilization method in accordance with a further embodiment of the present invention is characterized in that the electrospray step comprises the steps of previously defining, on the basis of a kind of the solution, an analytical curve representing a relationship between a duration of electrostatic atomization and a thickness of the microstructure, suing the analytical curve corresponding to the kind of the solution used to define the duration of the electrostatic atomization depending on a desired film thickness.

More concretely, the step may preferably be of: previously defining, on the basis of a kind of the solution, at least one of an analytical curve that represents the relationship between the concentration of the solution and the thickness of the microstructure; an analytical curve that represents the relationship between the average molecular weight of the objective substance in the solution and the thickness of the microstructure; and an analytical curve that represents the relationship between the average particle size and the thickness of the microstructure; and using the analytical curve corresponding to the kind of the solution used to define the duration of electrostatic atomization on the basis of a desired film thickness.

Alternatively, the electrospray step may also preferably be of: previously defining, on the basis of a kind of the solution, an analytical curve that represents the relationship between the concentration of the solution and the diameter of fiber that constitutes the fibrous microstructure; and using the analytical curve corresponding to the kind of the solution to define the concentration of the solution on the basis of the desired diameter of the fiber. In other words, it is preferable to define the concentration of the solution on the basis of the desired diameter of the fiber that constitutes the fibrous microstructure.

According to the invention, if the various analytical curves are made once, it becomes possible to prepare a thin film (three-dimensional microstructure) having the desired thickness and the desired microstructure or a thin film (three-dimensional microstructure) comprising a fiber having the desired diameter, simply and easily with good reproducibility. For instance, data of these various analytical curves may be stored in a storage to determine the duration of spraying, the concentration of the solution, and so on with reference to the compatible analytical curve date on the basis of the information about the solution (including the name of the objective substance, the concentration of the solution, the desired thickness of the microstructure, and the desired diameter). Therefore, it becomes possible to fix the desired film thickness and the desired diameter of objective substance by automatically adjusting the duration of spraying, the concentration of the solution, and so on.

In addition, an immobilization method in accordance with a further embodiment of the present invention is characterized in that the material to be coated is one of a substrate having at least slight electrical conductivity, a film, a polygonal column-shaped member, a cylindrical member, a fine particle, a globular substance, or a porous body.

According to the present invention, it becomes possible to immobilize/deposit the objective substance on the material to be coated of any of various configurations. In this way, if the objective substance can be immobilized on any of wide variety of objects to be coated while retaining its functionality and/or activity, it becomes possible to utilize the immobilized/deposited objective substance in any of various applications. For instance, if biopolymers, which have certain medical benefits, can be immobilized on the surface of a fine particle, a globular substance, or a porous body while retaining its functionality and/or activity, it is expected to make use of a fine particle covered with such a biopolymer as a drug in DDS (drug delivery system).

Furthermore, an immobilization method in accordance with a still further embodiment of the present invention, where the material to be coated is insulative, is characterized in that
the immobilization method further comprises the step of supplying ionic wind generated by means of an ion generator to remove electricity.

When the material to be coated is insulative, the electrical charge belonging to the immobilized microstructure is being held as it is. Thus, it can be difficult to allow an additionally sprayed objective substance to be subsequently immobilized because of being electrostatically repelled. However, according to the present invention, the electrostatic charge of the charged microstructure on the material to be coated can be removed by ionic wind. Thus, it becomes possible to immobilize the objective substance on an object to be coated made of an insulative material in a stable manner.

In addition, an immobilization method in accordance with a further embodiment of the present invention is characterized in that the electrospray step uses as the objective substance a substance suitable for the formation of a fiber, and the objective substance is then electrostatically atomized to form a fibrous microstructure, and the immobilization step immobilizes the fibrous microstructure on the material to be coated.

The material suitable for the formation of the fiber may preferably be a linear polymer.

According to the present invention, a three-dimensional mesh structure (porous body) or a nonwoven fabric structure having a film thickness on the order of nanometers, which consists of a fibrous fine structure having a diameter on the order of nanometers, can be formed. The mesh structure or the nonwoven fabric structure is a continuous structure made of a porous material having an extensively large surface area, so that it may be used in various applications of catalyst, sensor tip, culture medium for regenerative medical care, biofilter, coloring fabric, and so on.

Furthermore, an immobilization method in accordance with a further embodiment of the present invention, where the material to be coated is a polygonal column-shaped member or a cylindrical member, is characterized by further comprising the step of winding up the fibrous microstructure on the surface of the material to be coated by rotating the material to be coated.

According to the present invention, a mesh or nonwoven fabric structure having a uniform film structure can be prepared effectively almost on the whole of the member over a large area.

Furthermore, an immobilization method in accordance with the present invention is characterized in that the electrospray step also comprises at least one of the steps of shifting or moving the capillary or changing the direction of spray by arbitrarily changing the angle of the capillary, and shifting the object to be coated. According to the present invention, the sifting the capillary or the object to be coated or the change of the capillary angle (i.e., the swing of the capillary or a member that supports the capillary) permits electrostatic atomization of the solution more uniformly to accumulate the objective substance on the more extent area of the material to be coated equally.

An immobilization method in accordance a further embodiment of the present invention is characterized in that the electrospray step also comprises the step of oscillating the capillary. According to the present invention, a thin film having a predetermined film thickness can be obtained in a short time as the electrostatic atomization is promoted by oscillation. In addition, when the objective substance is suitable for the formation of a fiber, the oscillation allows the extension of a fibrous structure to permit the formation of a more elongated fibrous structure. In other words, according to the present invention, a substance suitable for the formation of a fiber is sprayed, collected, and wound up, therapy allowing a stable fiber (a single continuous glass fiber) or a short fiber to be twisted to prepare spun yarn having a fiber diameter on the order of nanometers. That is, the present invention may be used as a spinning method of a fiber having a fiber diameter on the order of nanometers.

Furthermore, an immobilization method in accordance with a further embodiment of the present invention is characterized in that the electrostatic atomization in the electrospray step is carried out using a capillary having a tip portion of 100 μm or more in inner diameter. According to the present invention, for example, an increase in spray speed and clogging of the capillary can be prevented when a hyper-viscous polymer is sprayed.

An immobilization method in accordance with a further embodiment of the present invention, the electrospray step performs the electrospray while providing a minute range of a periodic change in voltage applied on the solution to distinguish an electrostatic atomization state and a gas discharging state (i.e., the state in which the electrostatic atomization is being terminated), and monitors an amount of change in current value of the solution using an ampere meter. According to the present invention, when the gas discharge occurs or the electrostatic atomization is suspended, the percentage change of current is large due to the change of voltage. On the other hand, during the spraying state, there is small change occurred. Thus, the spraying state and the gas-discharging state can be distinguished from each other. In other words, it becomes possible to precisely grasp whether the electrospray is smoothly carried out and also to precisely grasp the amount of spraying. Therefore, the film thickness of the microstructure can be more precisely controlled.

Furthermore, an immobilization method in accordance with the present invention is characterized in that the electrospray step comprises any of the steps of adjusting the pressure of the solution when the solution is supplied to the capillary, adjusting the flow rate (volume) of the solution, or adjusting so as to establish a constant relational expression between the pressure and the flow rate of the solution. For instance, for controlling so as to establish the constant relational expression, the control may carried out so as to establish the following equation with respect to pressure P:
P=b(Vc−V)+c
(wherein b, c: constant, v: actually discharged volume, volume-indicating value: Vc=at, a: constant, t: time)

Furthermore, an immobilization method in accordance with a further embodiment of the present invention is characterized in that the electrospray step comprises any of the steps of adjusting a voltage at constant when the voltage is applied on the solution, adjusting the voltage so that a current passing through the solution becomes constant, or adjusting the voltage to establish a constant relationship between the voltage and the current (i.e., impedance control).

Furthermore, an immobilization method in accordance with a further embodiment of the present invention is characterized in that the raw material of the capillary is any of a metal, glass, silicon, or polymer material.

Furthermore, an immobilization method in accordance with a further embodiment of the invention is characterized in that, when multiple capillaries are provided, the electrospray step also comprises the step of adjusting each of a voltage or a current supplied to the solution contained in each of the capillaries. According to the present invention, the voltages supplied to the respective solutions placed in the respective capillaries can be independently controlled. Thus, it becomes possible to stably carry out electrostatic atomization on all of the capillaries.

Furthermore, an immobilization method in accordance with a further embodiment of the present invention is characterized in that multiple capillaries are provided, and the electrospray step comprises the step of dividing the solution to supply the solution to the multiple capillaries by use of a connector having the same number of output tubes as that of the capillaries per a single input tube, where each of the output tubes has its major axis (in the direction along which the solution flows) inclined at the same angle as that of the major axis (in the direction along which the solution flows) of the input tube, and the major axis of each of the output tubes is provided so as to form the same angle with the major axis of the adjacent output tube (here, each output tube has the same inner tube). According to the present invention, when the ESD method is carried out using multiple capillaries, the unevenness of a flow rate (i.e., the quantity of flow) caused by branched tubing can be avoided. Besides, the solution can be fed uniformly to each capillary, thereby more uniform microstructure can be created.

Furthermore, an immobilization method in accordance with a further embodiment of the present invention is characterized in that multiple capillaries are provided and each of these capillary is equipped with multiple tubes having their valves, and the electrospray step comprises the step of individually opening or closing the valve, concentrating the pressure force of the solution to at least only one of the capillaries so that degassing and/or dipping can be easily performed.

Furthermore, an immobilization method in accordance with a further embodiment of the present invention is characterized in that a portion to be touched with the solution and/or the electrostatically atomized objective substance is tolerative with respect to the solution and/or the objective substance.

According to the present invention, it is possible to immobilize the objective substance from a solvent or solute having corrosiveness'.

In addition, an immobilization method in accordance with a further embodiment of the present invention is characterized by further comprising the step of using at least one of a collimator electrode, means for supplying an ion flow, or means for supplying a pressure air to converge the objective substance electrostatically atomized in the electrospray step.

According to the present invention, the objective substance that flows toward the material to be coated of the target can be effectively converged.

In addition, an immobilization method in accordance with a further embodiment of the present invention surrounds a space in which at least both the electrostatic atomization and the immobilization will be carried out and then inert gas and/or clean dry air are/is supplied into the case.

According to the present invention, the inert gas may prevent the objective substance from deteriorating its activity and functionality, while the cleaned dry air may promote the evaluation of a solvent, so that the objective substance can be immobilized on an object to be coated while almost being dried, thereby preventing the activity and functionality of the objective substance from being deteriorated.

Furthermore, an immobilization method in accordance with a further embodiment of the present invention is characterized by further comprising the step of carrying out pressure reduction or evacuation in the inside of the case. According to the present invention, the mobility of the present of a droplet of the objective substance electrostatically atomized under reduced pressure, so that the electrostatic atomization can be efficiently carried out.

The present invention has been described in the mode of methods as described above. However, the present invention can be realized as embodiments of an apparatus and a manufacturing process, which correspond to the above methods.

For instance, an immobilization apparatus is characterized by comprising:
means for electrospraying, by which a solution containing at least one objective substance is supplied into a capillary and an electric voltage is then applied on the solution to allow electrostatic atomization thereof;
means for supporting an object, which is to be coated and has an arbitrary shape (i.e., any configuration), on which the objective substance is immobilized in a dried state by an electrostatic force while retaining functionality and/or activity of the objective substance to form a dried microstructure having a thickness on the order of nanometers; and
at least one of means for shifting the capillary, means for changing the angle of the capillary to an arbitrary angle, or means for shifting the object or target to be coated.

The present immobilization apparatus may provide as the object to be coated a polygonal column-shaped member or a cylindrical member and may comprise means for winding up the fibrous microstructure on the surface of the object to be coated by rotating the object to be coated.

The means for electrospraying performs electrostatic atomization while providing a minute range of a periodic change in voltage applied on the solution.

Also, the immobilization apparatus in accordance with one embodiment of the present invention is characterized by further comprising means for measuring a current, which monitors an amount of change in current value of the solution.

Furthermore, for instance, a method of manufacturing a microstructure having a thickness on the order of nanometers, is characterized by comprising the steps of carrying out electrospray by which a solution containing at least one objective substance is supplied into a capillary and an electric voltage is then applied on the solution to allow electrostatic atomization thereof; and
electrostatically immobilizing the objective substance in the solution atomized by the electrospray step on an object, which is to be coated and has an arbitrary shape (i.e., any configuration), in almost the dry state while retaining the functionality and/or activity of the objective substance to form a dried microstructure having a thickness on the order of nanometers.

### BRIEF DESCRIPTION OF THE DRAWINGS

FIG. 1 is a block diagram showing the basic construction of an immobilization apparatus with a single capillary used in an immobilization method according to the present invention;

FIG. 2 is a block diagram showing a modification example of the immobilization apparatus with a single capillary used in the immobilization method according to the present invention;

FIG. 3 is a block diagram showing an alternative modification example of the immobilization apparatus with a single capillary used in the immobilization method according to the present invention;

FIG. 4A is a diagrammatic view showing a multi-nozzle type capillary used in the immobilization method according to the present invention, and FIG. 4B is a sectional view of the multi-nozzle type capillary;

FIG. 5 is a block diagram of an electronic circuit that produces voltage applied to electrodes provided in multiple capillaries;

FIG. 6 is a schematic view showing the immobilization of an objective substance onto the surface of a fine spherical particle (object to be coated) using the immobilization apparatus according to the present invention;

FIG. 7 is a block diagram showing a further alternative modification example the immobilization apparatus with a single capillary used in the immobilization method according to the present invention;

FIG. 8 is a block diagram showing a modification example of the immobilization apparatus shown in FIG. 7;

FIG. 9 is an AFM image obtained from the measurement with a high-resolution atomic force microscope (AFM), of a thin film of polyethylene glycol (PEG) created on a substrate by the immobilization method according to the present invention;

FIG. 10 is an electron micrograph (at ×10,000 magnification) of a thin film of invertase created on a substrate by the immobilization method according to the present invention;

FIG. 11 is an electron micrograph (at ×10,000 magnification) of a thin film of invertase created on a substrate by the immobilization method according to the present invention;

FIG. 12 is an electron micrograph (at ×10,000 magnification) of a thin film of invertase created on a substrate by the immobilization method according to the present invention;

FIG. 13 is an electron micrograph (at ×10,000 magnification) of a thin film of invertase created on a substrate by the immobilization method according to the present invention;

FIG. 14 is an electron micrograph (at ×10,000 magnification) of a thin film of invertase created on a substrate by the immobilization method according to the present invention;

FIG. 15 is an electron micrograph (at ×10,000 magnification) of a thin film of invertase created on a substrate by the immobilization method according to the present invention;

FIG. 16 is an electron micrograph (at ×10,000 magnification) of a thin film of invertase created on a substrate by the immobilization method according to the present invention;

FIG. 17 is an electron micrograph (at ×10,000 magnification) of a thin film of invertase created on a substrate by the immobilization method according to the present invention;

FIG. 18 is an electron micrograph (at ×40,000 magnification) of a thin film of invertase created on a substrate by the immobilization method according to the present invention;

FIG. 19 is an electron micrograph (at ×40,000 magnification) of a thin film of lactalbumin (a-Lactalbumin) created on a substrate by the immobilization method according to the present invention;

FIG. 20 is an electron micrograph (at ×40,000 magnification) of a thin film of polyacrylic acid (PAA, with an average molecular weight of 250,000) created on a substrate by the immobilization method according to the present invention;

FIG. 21 is an electron micrograph (at ×40,000 magnification) of a thin film of polyethylene glycol (PEG, with an average molecular weight of 500,000) created on a substrate by the immobilization method according to the present invention;

FIG. 22 is an electron micrograph (at ×10,000 magnification) of a thin film of polyethylene glycol (PEG, with an average molecular weight of 4,000 to 500,000) created on a substrate by the immobilization method according to the present invention;

FIG. 23 is an electron micrograph (at ×10,000 magnification) of a thin film of polyethylene glycol (PEG, with an average molecular weight of 4,000 to 500,000) created on a substrate by the immobilization method according to the present invention;

FIG. 24 is an electron micrograph (at ×10,000 magnification) of a thin film of polyethylene glycol (PEG, with an average molecular weight of 4,000 to 500,000) created on a substrate by the immobilization method according to the present invention;

FIG. 25 is an electron micrograph (at ×10,000 magnification) of a thin film of polyacrylic acid (PAA, with an average molecular weight of 4,000 to 250,000) created on a substrate by the immobilization method according to the present invention;

FIG. 26 is an electron micrograph (at ×10,000 magnification) of a thin film of polyacrylic acid (PAA, with an average molecular weight of 4,000 to 250,000) created on a substrate by the immobilization method according to the present invention;

FIG. 27 is an electron micrograph (at ×10,000 magnification) of a thin film of polyacrylic acid (PAA, with an average molecular weight of 4,000 to 250,000) created on a substrate by the immobilization method according to the present invention;

FIG. 28 is an electron micrograph (at ×10,000 magnification) of a thin film of polyethylene glycol (PEG, with an average molecular weight of 500,000) created on a substrate by the immobilization method according to the present invention;

FIG. 29 is an electron micrograph (at ×10,000 magnification) of a thin film of polyethylene glycol (PEG, with an average molecular weight of 500,000) created on a substrate by the immobilization method according to the present invention;

FIG. 30 is an electron micrograph (at ×10,000 magnification) of a thin film of polyethylene glycol (PEG, with an average molecular weight of 500,000) created on a substrate by the immobilization method according to the present invention;

FIG. 31 is an electron micrograph (at ×40,000 magnification) of a thin film of polyacrylic acid (PAA, with an average molecular weight of 250,000) created on a substrate by the immobilization method according to the present invention;

FIG. 32 is an electron micrograph (at ×40,000 magnification) of a thin film of polyethylene glycol (PEG, with an average molecular weight of 500,000) created on a substrate by the immobilization method according to the present invention;

FIG. 33 is an electron micrograph of a thin film of polyethylene glycol (PEG) created on a substrate by the immobilization method according to the present invention;

FIG. 34 is an electron micrograph of a thin film of polyethylene glycol (PEG) created on a substrate by the immobilization method according to the present invention;

FIG. 35 is an electron micrograph of a thin film of polyethylene glycol (PEG) created on a substrate by the immobilization method according to the present invention;

FIG. 36 is a graph of a calibration curve showing the relationship between the concentration of a solution and the diameter of an immobilized fiber (objective substance);

FIG. 37A is a perspective view of a connector used in an immobilization apparatus with multiple capillaries according to the present invention, and FIG. 37B is a sectional view showing the connector shown in FIG. 37A, which is taken along the X-Y line;

FIG. 38A is a graph showing the relationship between current and voltage of a solution during electrospraying, FIG. 38B is a graph showing the time course of voltage when voltage applied to a solution is varied at a predetermined period, and FIG. 38C is a graph showing the time course of current running in a solution when voltage is varied as illustrated in FIG. 38B;

FIG. 39A is a block diagram showing a modification example of a substrate used in the immobilization apparatus according to the present invention;

FIG. 39B is a block diagram showing an alternative modification example of the substrate; and

FIG. 40 is a block diagram showing a modification example of a capillary used in the immobilization apparatus according to the present invention.

### DETAILED DESCRIPTION OF THE PREFERRED EMBODIMENTS

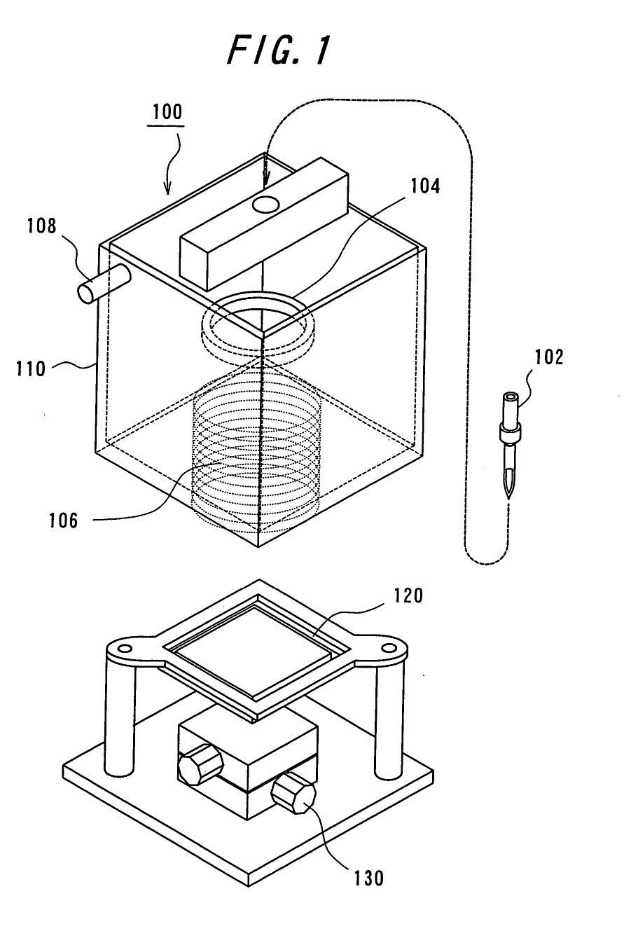

FIG. 1 is a block diagram showing the basic construction of an immobilization apparatus with a single capillary used in an immobilization method according to the present invention. As shown in the drawing, an immobilization apparatus 100 of the present invention comprises a capillary 102, a guard ring 104, a shield 106, a dried air inlet 108, a case 110, a conductive substrate (object to be coated) 120, and a XY stage 130. The capillary 102 comprises an electrode (not shown), and this electrode is used to apply predetermined high voltage to a solution containing an objective substance, which is supplied into the capillary 102. The solution is electrostatically sprayed as fine droplets from the tip of the capillary 102 toward the conductive substrate 120. The guard ring 104 is supplied with collimating voltage, by which the electrostatically sprayed fine droplets efficiently gather near the center of the guard ring 104 and proceed to the grounded conductive substrate 120, with them dried during flight. The fine droplets are then immobilized in an almost dried state with a thickness of the order of a nanometer onto the surface of the conductive substrate 120 while the functionality and/or activity of the objective substance is maintained. Clean dried air is supplied from the dried air inlet 108 to the case 110 to rapidly dry the objective substance. The objective substance can be immobilized in uniform thickness and can further be immobilized uniformly in the large area of the substrate by optionally shifting (moving) the conductive substrate 120 with the XY stage.

A mask, though not illustrated, may be provided between the capillary and the substrate. When an insulating substance is employed as the substrate used as an object to be coated, the substrate cannot be grounded (i.e., destaticized). Therefore, it is preferred that the immobilization apparatus of the present invention should be provided with an ion generator (not shown), by which generated ionic wind is sprayed on a microstructure on the above-described insulating material to be coated to conduct destaticization. The aspiration and adhesion of an electrically charged particle or nanofiber (objective substance) to the substrate through electrostatic force is required for performing electrostatic spray. Therefore, if an material without electrical conductivity that dissipates the electric charge of a deposit is electrostatically sprayed, the substrate is electrically charged and repulses a newly sprayed nanofiber or the like, so that successive deposition is difficult. For solving this, it is necessary to remove the electric charge of the substrate by some method. One possible method is a method of destaticization using ionic wind generated from an ion generator that employs corona discharge or the like. In this method, both positive and negative ions associated with gas discharge phenomena in atmosphere such as corona discharge are sent near the substrate, and only the ion oppositely charged to the electric charge of the substrate is attached to the substrate to neutralize the electric charge. This allows successive electrostatic spray. A neutralization electrode or the like can be provided in the vicinity of the discharge site to send only a positive ion or negative ion as wind, thereby actively destaticizing the substrate. In addition, collection efficiency can actively be enhanced by electrically charging either of such a positive ion or negative ion to a potential opposite to that of the electrostatically sprayed nanofiber. There are two possible methods for sending ionic wind, one of which is a method of sending ionic wind simultaneously with ESD and another of which is a method of alternately sending spray by ESD and ionic wind. In the latter case, more stable spray seems to be possible because the objective substance electrostatically sprayed as fine particles becomes unsusceptible to wind.

Although not illustrated, the capillary 102 is connected via a tube or a pump to a sample solution bottle. The capacity of the bottle is preferably in the range of 1 ml to 10000 ml. Alternatively, plural (e.g., one to several tens) sample solution bottles can be prepared in advance and switched to supply a desired solution to the capillary. In this case, a different type of solution may be sealed in each of the bottles.

When a large area is electrosprayed, a shifter (not shown) that moves the capillary 102 in a single or double or more axes can also be provided. In this case, it is possible to uniformly spray the large area of the object to be coated.

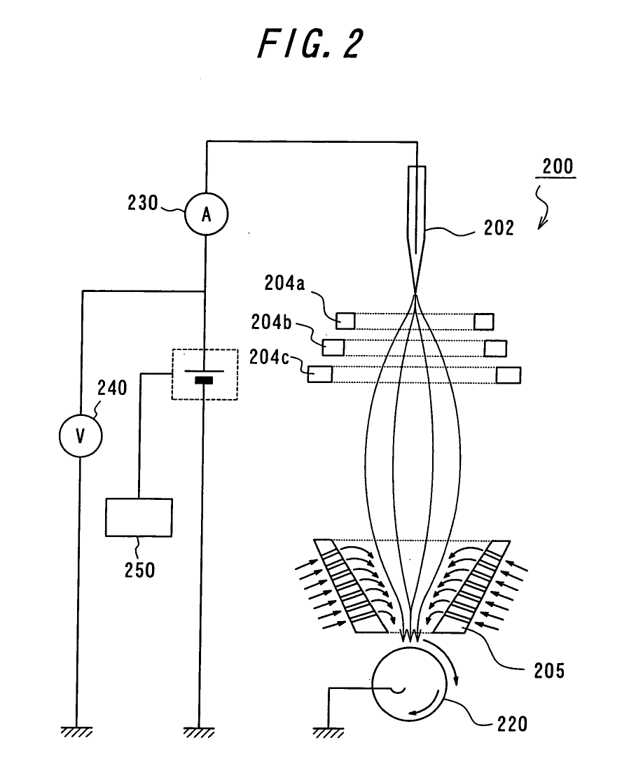

FIG. 2 is a block diagram showing a modification example of the immobilization apparatus with a single capillary used in the immobilization method according to the present invention. As shown in the drawing, an immobilization apparatus 200 of the present invention comprises a capillary 202, accelerating/focusing electrodes 204a, 204b, and 204c, a conductive porous collimator 205, and a conductive cylinder (object to be coated) 220. Electrostatically sprayed droplets containing an objective substance are accelerated or focused by the accelerating/focusing electrodes 204a, 204b, and 204c. The droplets then move to the conductive cylinder 220 by the attraction of an electric field formed by the grounded conductive cylinder 220. Although the collimator 205 can electrically aspirate the electrostatically sprayed droplets (objective substance) by the application of voltage slightly higher than ground voltage, pressurized air runs on the surface of the collimator 205, and the objective substance is focused without landing on the surface of the collimator. That is, this collimator 205 has a through-hole as shown in the drawing, through which pressurized air supplied from without inward. Therefore, the objective substance is centrally focused without landing on the surface of the collimator.

Eventually, the objective substance arrives at the grounded conductive cylinder 220 and is immobilized thereon. This conductive cylinder 220 rotates at an appropriate rate. The focused objective substance is uniformly immobilized in an almost dried state on the surface of the cylinder 220, while its functionality and activity are maintained.

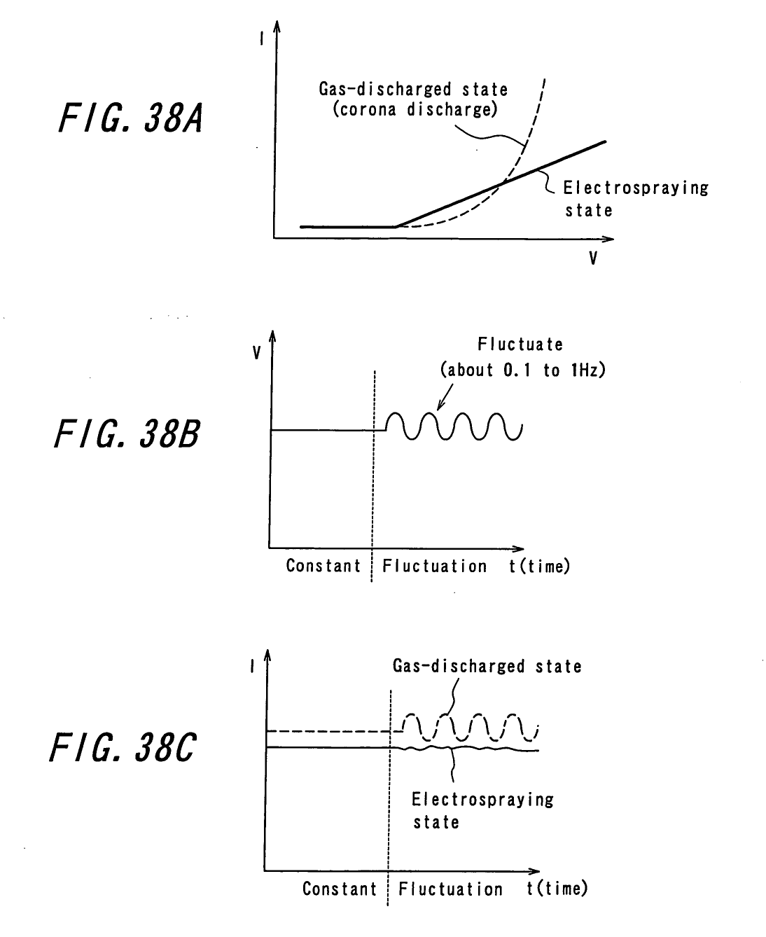

The immobilization apparatus 200 of the present invention also comprises an ammeter 230, a voltmeter 240, and a voltage controller 250 (these will be described below in detail with reference to FIG. 38).

If a substance suitable for fiber formation (e.g., a linear polymer) is used as the objective substance, the immobilization apparatus of the present invention can be used as an apparatus that reels the objective substance as a nanofiber, with its activity and functionality maintained.

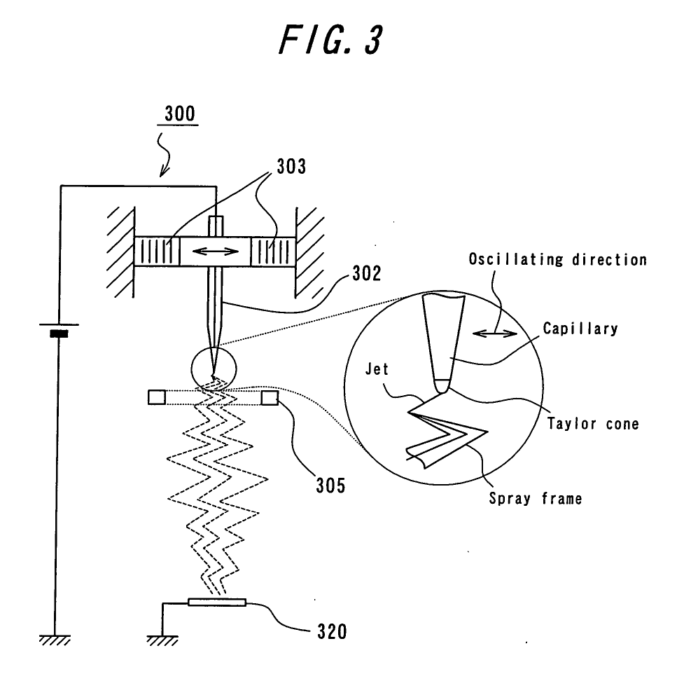

FIG. 3 is a block diagram showing an alternative modification example of the immobilization apparatus with a single capillary used in the immobilization method according to the present invention. As shown in the drawing, an immobilization apparatus 300 of the present invention comprises a capillary 302, a piezoelectric actuator 303, a collimator electrode 305, and a substrate 320. The capillary 302 that serves as a nozzle during electrostatic spraying is connected to the piezoelectric actuator 303 as oscillation means, by which the capillary is oscillated or shifted in a horizontal direction. As shown in an enlarged view in the drawing, an objective substance sprayed out of Taylor Cone formed in the tip of the capillary is extended by this oscillation. That is, this oscillation allows the electrostatic spray of the objective substance extended into a fibrous form and consequently allows the immobilization of the objective substance as a fibrous substance having a smaller diameter. In addition, it is possible to form a nonwoven fabric-shaped thin film having a smaller thickness. Namely, by extending the objective substance into a fibrous form, the objective substance can be immobilized with a thickness of the order of a nanometer, or the fibrous substance forming that thin film can be immobilized with a diameter of the order of a nanometer.

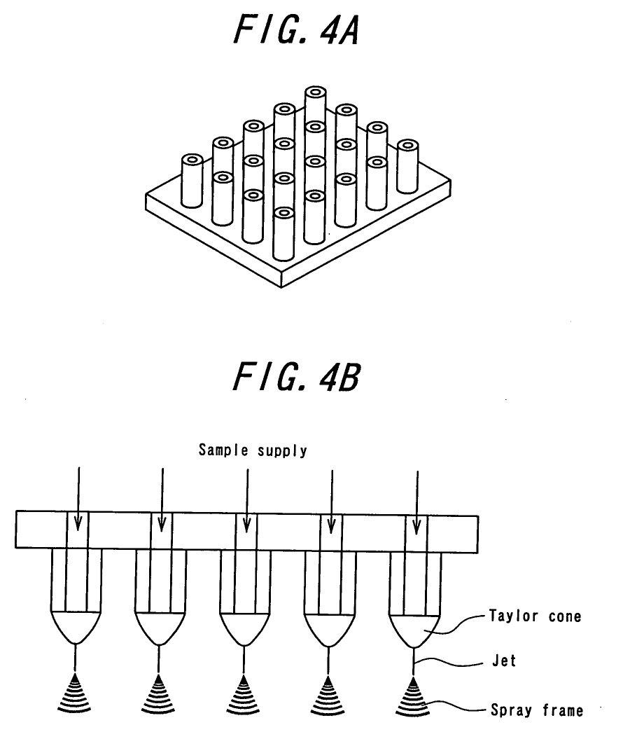

FIG. 4A is a diagrammatic view showing a multi-nozzle type capillary used in the immobilization method according to the present invention, and FIG. 4B is a sectional view of the multi-nozzle type capillary. The use of such a multi-nozzle allows improvement in the efficiency of electrostatic spray. As shown in the drawing, the multi-nozzle refers to plural capillaries each having a diameter of approximately 100 μm or less, which are formed on one substrate. The multi-nozzle can be formed by, for example, silicon micromachining techniques, thick film photoresist techniques, or ultraprecision machining methods. A sample solution is supplied into all of these nozzles and simultaneously electrostatically sprayed by the application of high voltage. As a result, fine droplets can be sprayed in large amounts to efficiently immobilize the objective substance.

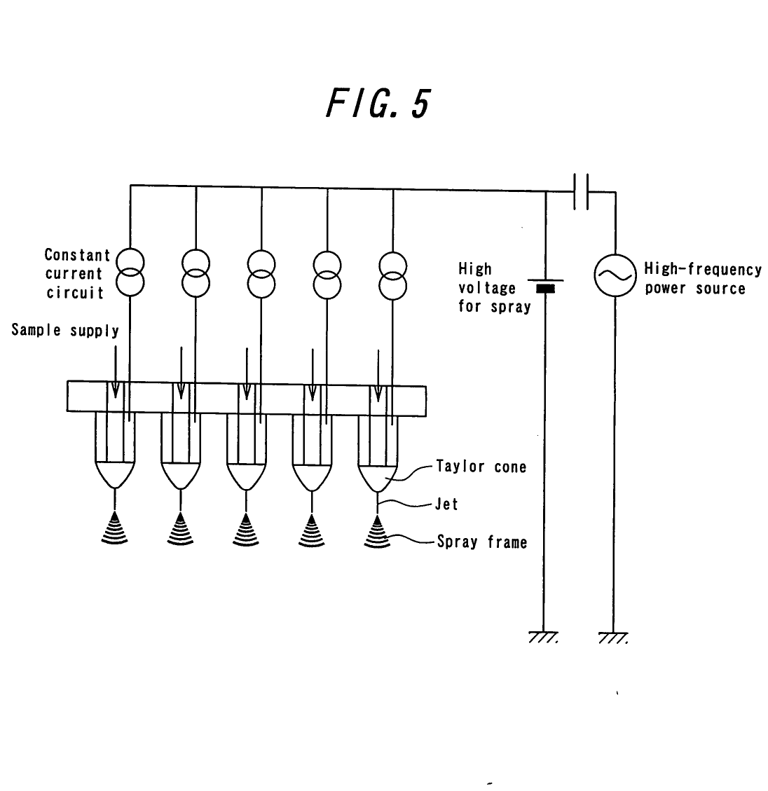

FIG. 5 is a block diagram of an electronic circuit that produces voltage applied to electrodes provided in multiple capillaries. Although an approach in which all of the electrodes provided in nozzles are rendered conductive and allowed to have the same potential would be taken on the multiple capillaries, slight variations in the size of the capillaries might change the strength of electric field concentration, and stable and simultaneous spray from all of the nozzles might be difficult to perform. Therefore, each of the nozzles can be individually insulated and respectively provided with a current-controlled circuit (constant current circuit) to thereby stably perform spray from all of the nozzles by a constant amount of current. In this case, it is also possible to stably maintain spray from plural nozzles by connecting an applied-voltage supply line via a capacitor to a high-frequency power source as shown in the drawing and intermittently supplying voltage to generate intermittent spray. This allows the electrostatic spray of fine droplets in large amounts and the stable immobilization of the objective substance at a high speed.

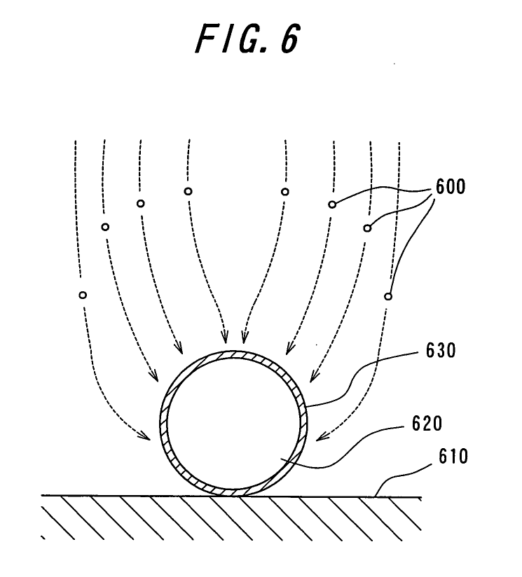

FIG. 6 is a schematic view showing the immobilization of an objective substance onto the surface of a fine spherical particle (object to be coated) using the immobilization apparatus according to the present invention. As shown in the drawing, an objective substance 600 that is electrostatic sprayed is immobilized on the surface of a fine particle 620 supported by a support 610 to form a coat 630 with a thickness of the order of a nanometer.

FIG. 7 is a block diagram showing a further alternative modification example the immobilization apparatus with a single capillary used in the immobilization method according to the present invention. In an immobilization apparatus 700, a nonconductive substrate 720 is placed on a grounded conductive electrode 710 as shown in the drawing. This conductive electrode 710 is required for generating a high electric field necessary for spray. The non-conductive substrate 720 is sprayed with ionic wind from laterally or from above, and its charge-up by ESD is removed (destaticized). Or otherwise, the nonconductive substrate 720 is electrically charged in advance to an opposite electric charge.

As shown in the drawing, an ion generator 740 generates an ion from a charge wire 742 (thin wire on the order of 100 μm or less) or an electrode having a pointed end by corona discharge or the like. This ion is carried by wind from a blower 746 and discharged through a mesh counterelectrode 748. The supply of ionic wind or the like for destaticization or electrification may be performed simultaneously with electrostatic spray. Alternatively, spray and ionic wind or the like may alternately be generated in order not to hinder the movement of the sprayed particles.

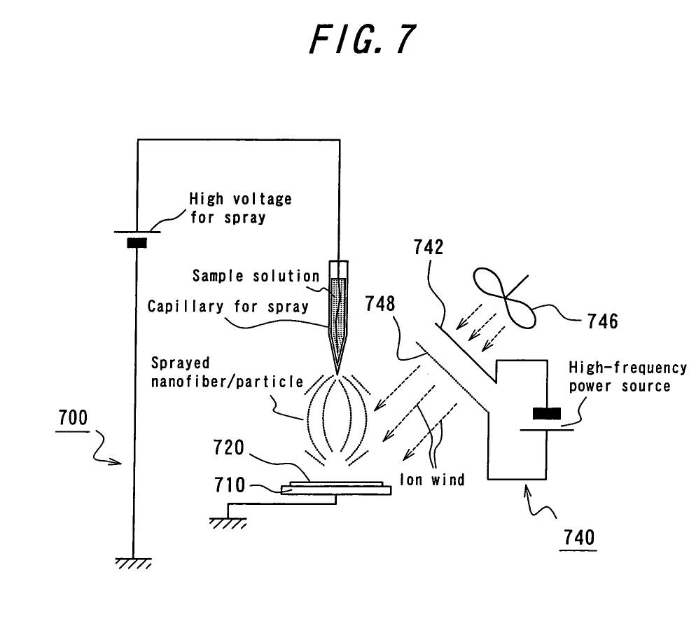

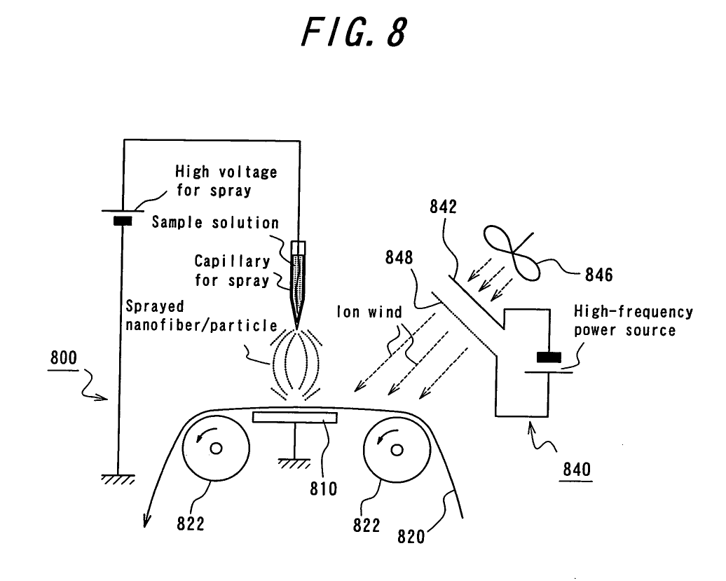

FIG. 8 is a block diagram showing a modification example of the immobilization apparatus shown in FIG. 7. In an immobilization apparatus 800, a nonconductive substrate (insulating raw material) 820 is moved at a constant speed or intermittently on a grounded conductive electrode 810, as shown in the drawing. For example, for moving the nonconductive substrate 820 that is strip-shaped or sheet-shaped, a reeler/conveyer 822 for reeling or conveying the substance or substrate as shown in the drawing is provided and rotated. The immobilization apparatus 800 shown in FIG. 8 comprises an ion generator 840 as with the immobilization apparatus shown in FIG. 7. This ion generator 840 comprises a charge wire 842, a blower 846, a counterelectrode (mesh) 848, and so on.

When a sample is successively immobilized as described above, a destaticization/electrification apparatus such as an ion generator is provided upstream of a mechanism for transporting the nonconductive raw material, and a part to be electrosprayed is provided downstream thereof. This allows the successive immobilization of the sample.

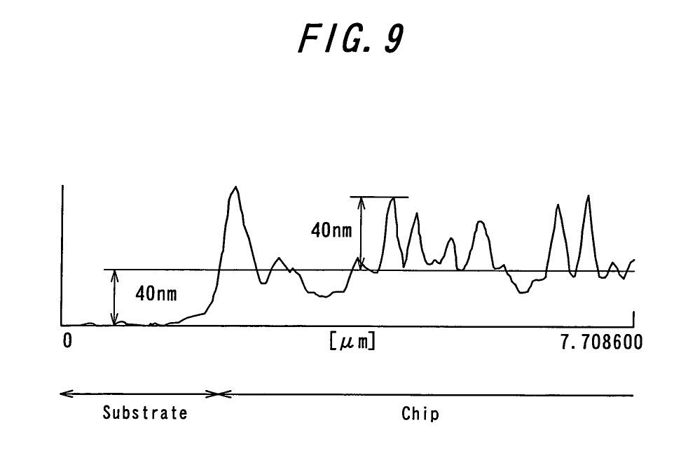

FIG. 9 is an AFM image obtained from the measurement with a high-resolution atomic force microscope (AFM), of a thin film of polyethylene glycol (PEG) created on a substrate by the immobilization method according to the present invention. Conditions for creating the thin film is as follows: PEG (polyethylene glycol) is used as an objective substance whose average molecular weight is 500K (500,000) and concentration is 2.5 g/L; voltage applied to the electrode in the capillary is 4000 V; space (within the case) in which electrostatic spray and immobilization are performed has a humidity of 20%; the distance between the substrate and the capillary is 5 cm; and electrostatic spray duration is 30 seconds. As shown in the drawing, it can be observed that the thin film of the objective substance with a thickness of approximately 20 nm to 80 nm is formed.

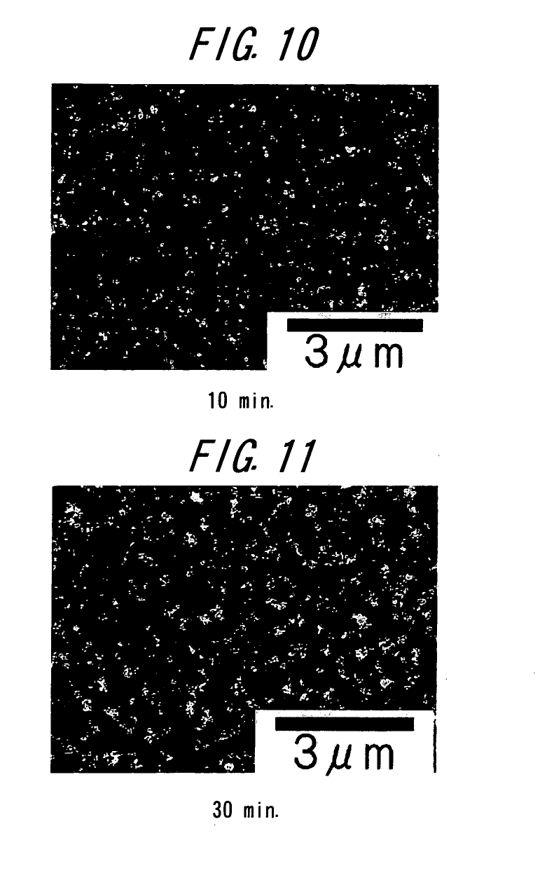

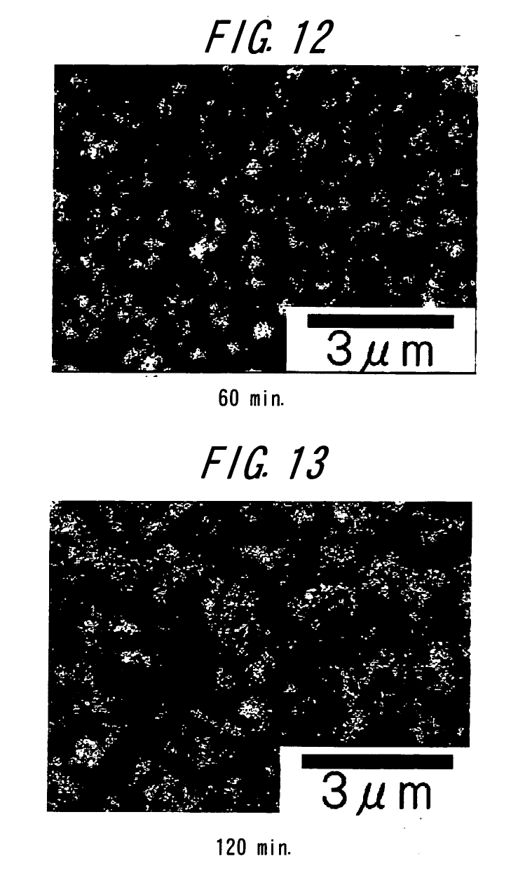

FIG. 10 to FIG. 13 are, respectively, an electron micrograph (at ×10,000 magnification) of a thin film of invertase created on a substrate by the immobilization method according to the present invention. Concerning conditions for creating the thin film, electrostatic spray duration is 10 minutes for FIG. 10, 30 minutes for FIG. 11, 60 minutes for FIG. 12, and 120 minutes for FIG. 13. The other conditions are the same in all of the drawings: invertase (derived from Baker's yeast, manufactured by Sigma) is used as an objective substance whose concentration is 0.5 g/L; voltage applied to the electrode in the capillary is approximately 2000 to 3000 V; space (within the case) in which electrostatic spray and immobilization are performed has a humidity of 20% or less; and the distance between the substrate and the capillary is approximately 5 cm. As shown in the drawings, it can be observed that the longer the electrostatic spray duration gets, the larger the size of convexoconcave becomes. It can also be observed that the size of the “particle” composing a microstructure (thin film) consisting of convexoconcave is almost the same throughout FIG. 10 to FIG. 13.

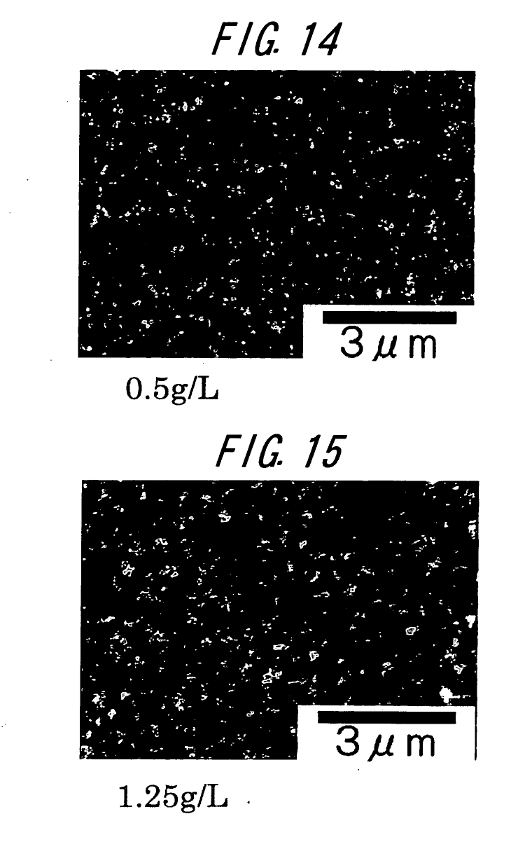

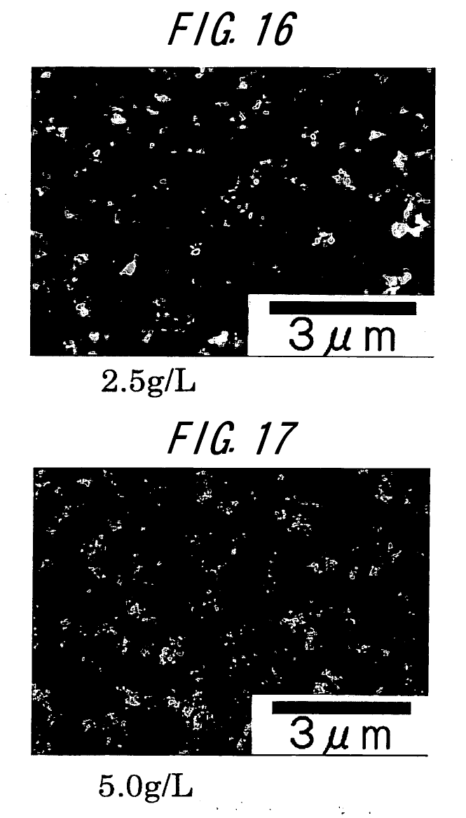

FIG. 14 to FIG. 17 are, respectively, an electron micrograph (at ×10,000 magnification) of a thin film of invertase created on a substrate by the immobilization method according to the present invention. Concerning conditions for creating the thin film, the concentration of the sample (objective substance) is 0.5 g/L for FIG. 14, 1.25 g/L for FIG. 15, 2.5 g/L for FIG. 16, and 5.0 g/L for FIG. 17. Besides, electrostatic spray duration is 10 minutes. The other conditions are the same as those for FIG. 10 to FIG. 13. As shown in the drawings, it can be observed that the thicker the concentration of the sample gets, the larger the size of convexoconcave becomes. It can also be observed that the size of the “particle” composing a microstructure (thin film) consisting of convexoconcave is almost the same throughout FIG. 14 to FIG. 17. Thus, the electrostatic spray duration and the concentration of the sample have similar effect on the circumstances under which the thin film is formed.

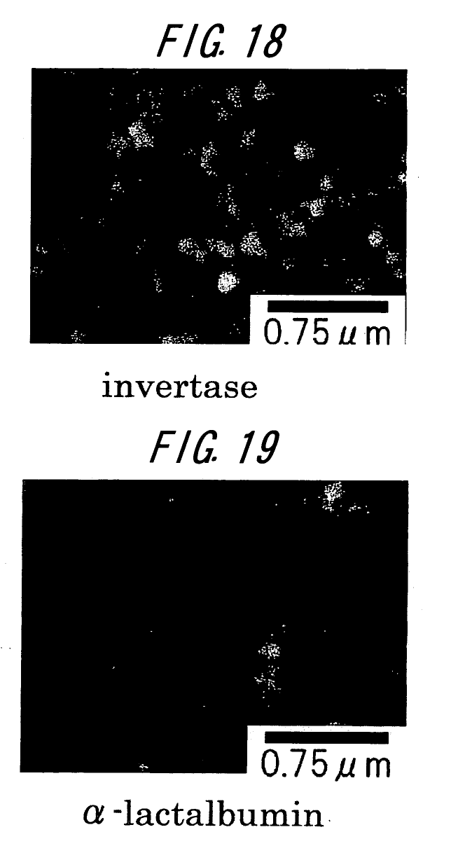

FIG. 18 is an electron micrograph (at ×40,000 magnification) of a thin film of invertase created on a substrate by the immobilization method according to the present invention. Conditions for creating the thin film is as follows: invertase (derived from Baker's yeast, manufactured by Sigma) is used as an objective substance whose concentration is 2.5 g/L; voltage applied to the electrode in the capillary is approximately 2000 to 3000 V; space (within the case) in which electrostatic spray and immobilization are performed has a humidity of 20% or less; the distance between the substrate and the capillary is approximately 5 cm; and electrostatic spray duration is 10 minutes. As shown in the drawing, it can be observed that this thin film is composed of spherical particles with a diameter of approximately several tens of nm to 100 nm.

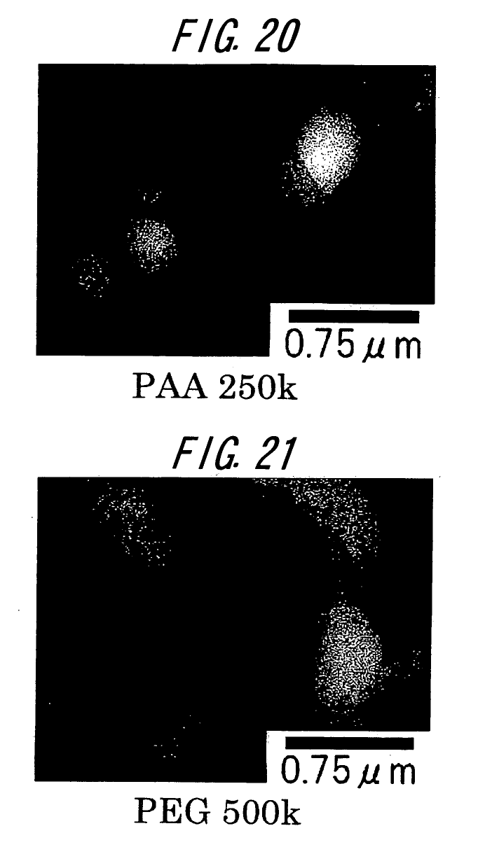

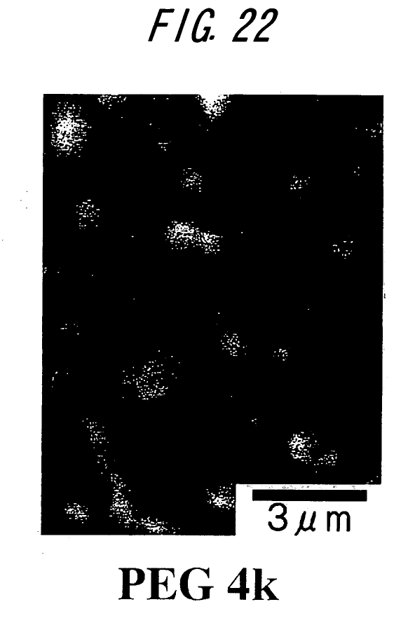

FIG. 19 is an electron micrograph (at ×40,000 magnification) of a thin film of lactalbumin (a-Lactalbumin) created on a substrate by the immobilization method according to the present invention. Concerning conditions for creating the thin film, lactalbumin (derived from Bovine milk, manufactured by Sigma) is used as an objective substance, and the other conditions are the same as those for FIG. 18. As shown in the drawing, it can be observed that this film has a three-dimensional reticular microstructure.

FIG. 20 is an electron micrograph (at ×40,000 magnification) of a thin film of polyacrylic acid (PAA, with an average molecular weight of 250,000) created on a substrate by the immobilization method according to the present invention. Conditions for creating the thin film are the same as those for FIG. 18 except for an objective substance. As shown in the drawing, it can be observed that this thin film has a three-dimensional reticular microstructure that has each elliptical particle with a diameter of approximately a hundred and several tens of nm to several hundreds of nm, both ends of which are connected to the other particles by reticularly fibrous strings.

FIG. 21 is an electron micrograph (at ×40,000 magnification) of a thin film of polyethylene glycol (PEG, with an average molecular weight of 500,000) created on a substrate by the immobilization method according to the present invention. Conditions for creating the thin film are the same as those for FIG. 18 except for an objective substance. As shown in the drawing, it can be observed that this thin film has a three-dimensional reticular microstructure that has each spherical particle with a diameter of approximately a hundred and several tens of nm to several hundreds of nm, which is connected to the other particles by reticularly fibrous strings. By comparison between FIG. 20 and FIG. 21, it can be observed that PEG has a higher density in the reticular structure and more fibrous strings connected per particle, than those of PAA.

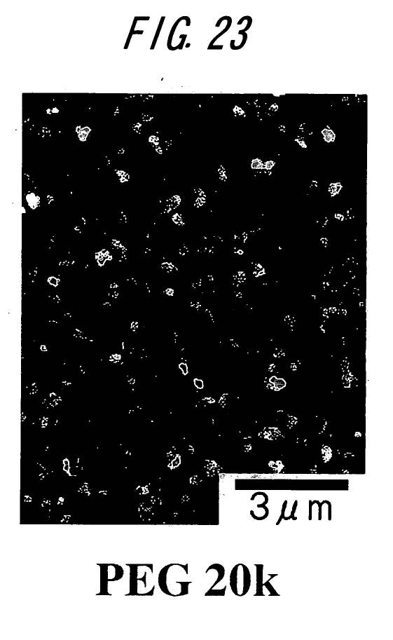

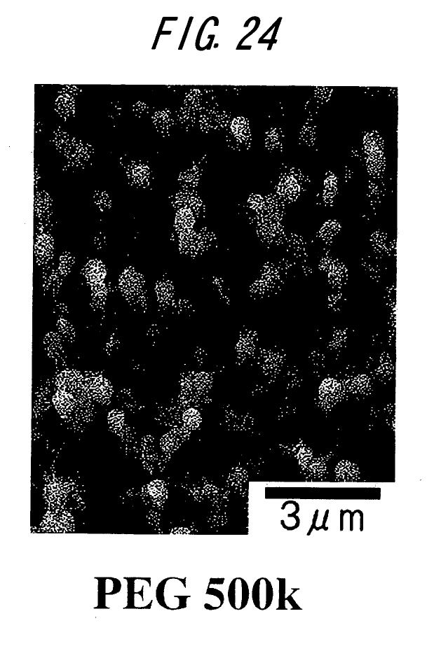

FIG. 22 to FIG. 24 are, respectively, an electron micrograph (at ×10,000 magnification) of a thin film of polyethylene glycol (PEG, with an average molecular weight of 4,000 to 500,000) created on a substrate by the immobilization method according to the present invention. Concerning conditions for creating the thin film, the average molecular weight of PEG is 4,000 for FIG. 22, 20,000 for FIG. 23, and 500,000 for FIG. 24. The other conditions for creating the thin film are the same as those for FIG. 18.

As shown in these drawings, it can be observed that these thin films each have a three-dimensional reticular microstructure that has each spherical particle with a diameter of approximately several nm to several hundreds of nm, which is connected to the other particles by reticularly fibrous strings. By comparison among these drawings, the three-dimensional reticular structure consisting of spherical particles and fibrous strings connecting them can be observed more clearly in PEG having a larger average molecular weight. However, in the case of the molecular weight of 4,000 (FIG. 22), the particles/fibrous structure could not be observed clearly due to problems with magnification.

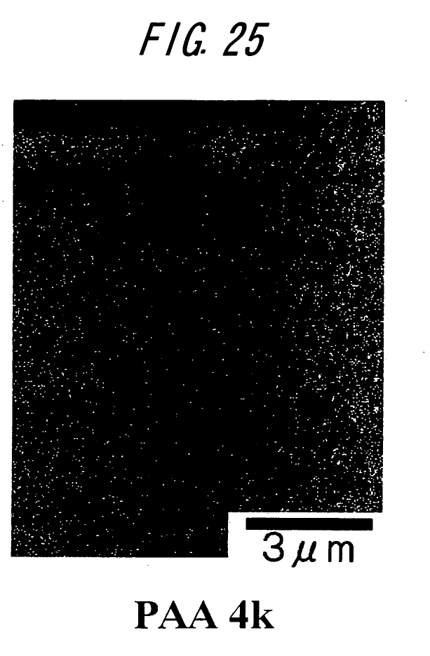

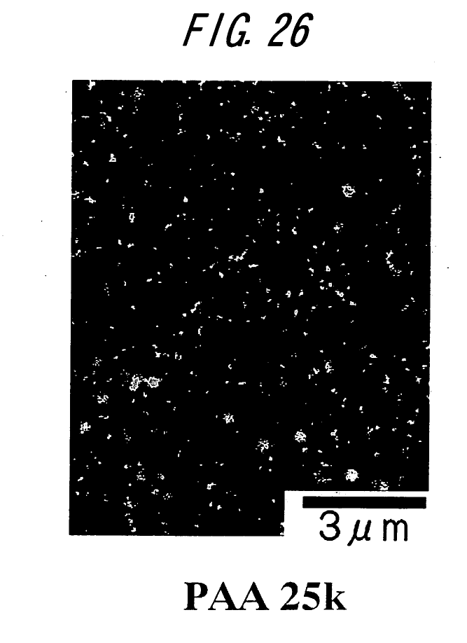

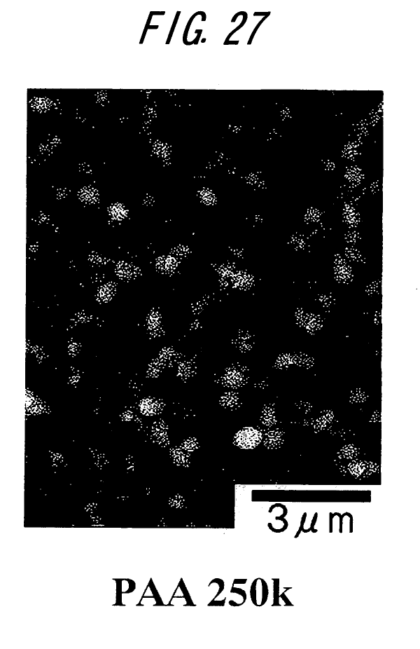

FIG. 25 to FIG. 27 are, respectively, an electron micrograph (at ×10,000 magnification) of a thin film of polyacrylic acid (PAA, with an average molecular weight of 4,000 to 250,000) created on a substrate by the immobilization method according to the present invention. Concerning conditions for creating the thin film, the average molecular weight of PAA is 4,000 for FIG. 25, 25,000 for FIG. 26, and 250,000 for FIG. 27. The other conditions for creating the thin film are the same as those for FIG. 18.

As shown in these drawings, it can be observed that these thin films each have a three-dimensional reticular microstructure that has each spherical particle with a diameter of approximately several nm to several hundreds of nm, which is connected to the other particles by reticularly fibrous strings. By comparison among these drawings, the three-dimensional reticular structure consisting of spherical particles and fibrous strings connecting them can be observed more clearly in PAA having a larger average molecular weight. However, in the case of the molecular weight of 4,000 (FIG. 25), the particles/fibrous structure could not be observed clearly due to problems with magnification.

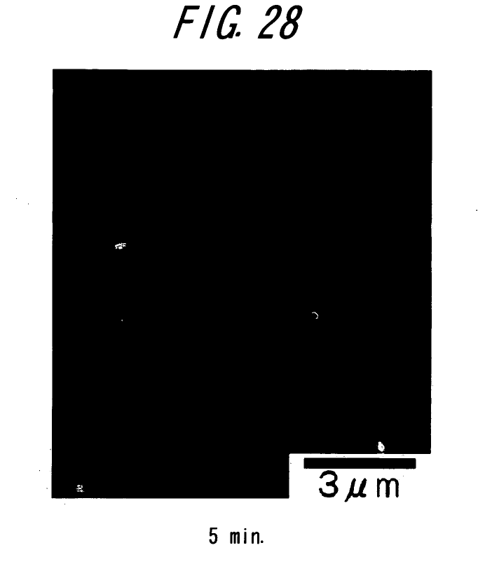

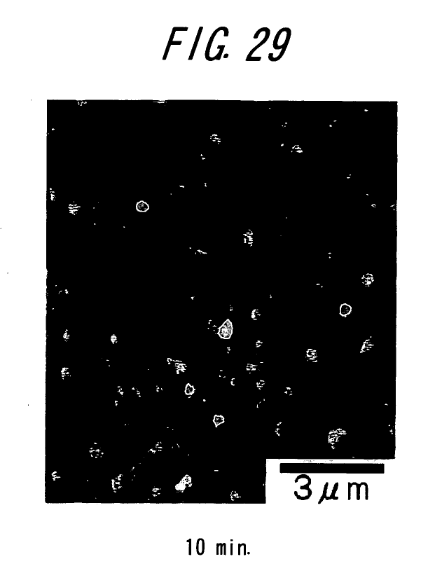

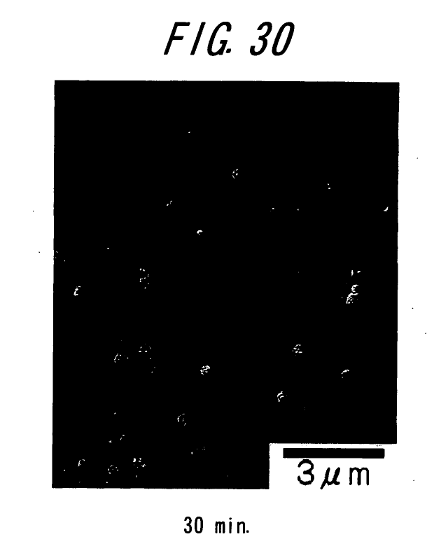

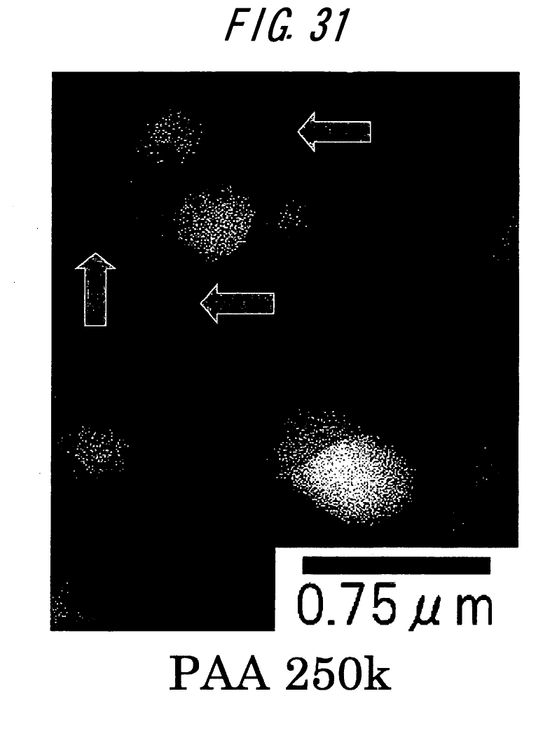

FIG. 28 to FIG. 30 are, respectively, an electron micrograph (at ×10,000 magnification) of a thin film of polyethylene glycol (PEG, with an average molecular weight of 500,000) created on a substrate by the immobilization method according to the present invention. Concerning conditions for creating the thin film, electrostatic spray duration is 5 minutes for FIG. 28, 10 minutes for FIG. 29, and 30 minutes for FIG. 30. The other conditions are the same as those for FIG. 18.

As shown in FIG. 29 and FIG. 30, it can be observed that these thin films each have a three-dimensional reticular microstructure that has each spherical particle with a diameter of approximately several tens of nm to several hundreds of nm, which is connected to the other particles by reticularly fibrous strings. In PEG applied to the electrostatic spray duration of 5 minutes (FIG. 28), the particles are present spottedly and solely on the surface of the substrate, so that fibrous strings connecting the particles together could not observed at that point.

FIG. 31 is an electron micrograph (at ×40,000 magnification) of a thin film of polyacrylic acid (PAA, with an average molecular weight of 250,000) created on a substrate by the immobilization method according to the present invention.

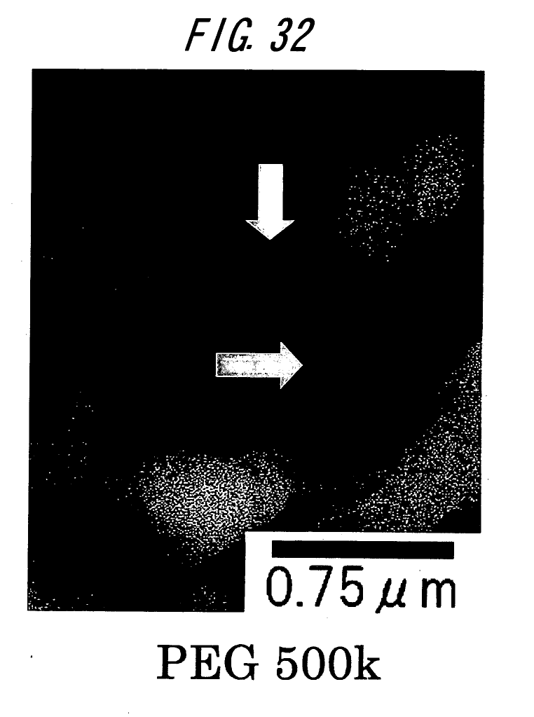

FIG. 32 is an electron micrograph (at ×40,000 magnification) of a thin film of polyethylene glycol (PEG, with an average molecular weight of 500,000) created on a substrate by the immobilization method according to the present invention.

Parts indicated by open arrows in the drawings are fibrous structures. Because, on high magnification, the surface of the thin film is damaged due to heat, the photograph is slightly blurred. However, in reality, the fibrous structure should be observed clearly. As shown in the drawing, particles having a diameter of approximately several hundreds of nm and fibers having a size of approximately several nm to a ten and several nm, which connect these particles can be observed.

It is noted that the biological activity and functionality of a biopolymer or the like composing the created thin film is maintained as a matter of course.

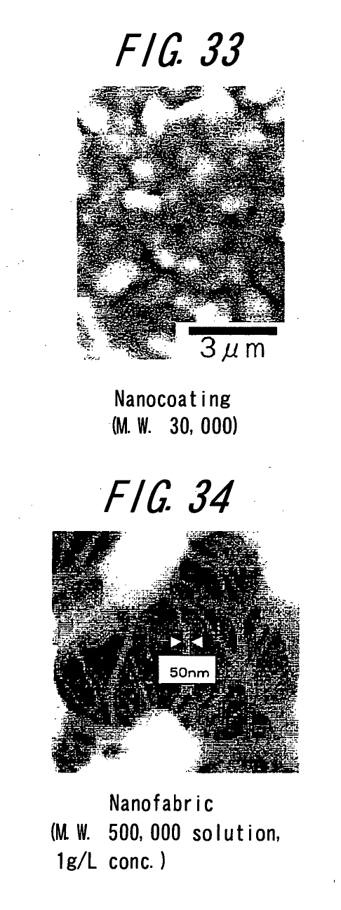

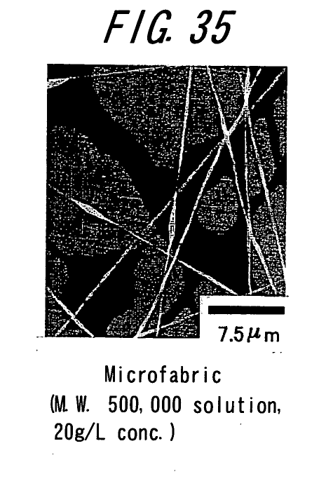

FIG. 33, FIG. 34, and FIG. 35 are, respectively, an electron micrograph of a thin film of polyethylene glycol (PEG) created on a substrate by the immobilization method according to the present invention. As shown in the drawing, for PEG having a molecular weight of 30,000 (FIG. 33), the thin film is composed of particulate substances and does not assume a fibrous form even by changing the concentration of a solution. In the immobilization method of the present invention, when PEG in the solution has a molecular weight of approximately 500,000 and a concentration of 1 g/L, a fibrous structure is formed as shown in FIG. 34, and when the concentration of a solution is as high as 20 g/L, the structure has a still larger fiber diameter as shown in FIG. 35. Experiments have demonstrated that PEG having a molecular weight more than 50,000 provides for a fibrous structure. It has also been found that a solution having a thinner concentration gives a smaller fiber diameter.

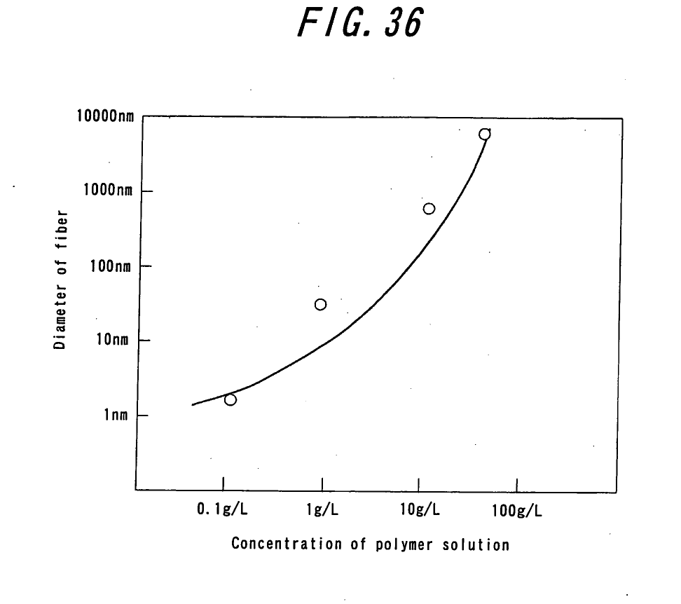

FIG. 36 is a graph of a calibration curve showing the relationship between the concentration of a solution for PEG having a molecular weight of 500,000 and the diameter of a fiber (objective substance) when the solution is immobilized by the method of the present invention. If the calibration curve as shown in the drawing is created on a type-by-type basis of solutions, the concentration of the solution is adjusted using this calibration, thereby allowing the easy adjustment of the fiber diameter of a created structure to a desired thickness. Especially by setting the concentration of the solution to a thin concentration, a microstructure (thin film) consisting of fibers having a diameter of several nm to several hundreds of nm can stably be created. For example, When PEG is used and a fiber diameter of several nm is desired, the concentration of the solution is set to approximately 0.1 g/L and when a fiber diameter of several tens of nm is desired, the concentration of the solution is set to approximately 1.0 g/L, thereby allowing the construction of a microstructure composed of fibers having a desired diameter. In the present Example, the calibration curve of PEG having a molecular weight of 500,000 was shown by way of example. However, a microstructure composed of fibers having a desired diameter can stably be created as long as a calibration curve is prepared for the other molecular weights or the other varieties of objective substances.

The microstructure created by the immobilization method, the apparatus, and the creating method according to the present invention is a porous body having a three-dimensional reticular structure consisting of particles of the order of a nanometer and fibrous strings, as described above. Thus, the microstructure can be expected to be applied, as a porous body that maintain the biological activity and functionality of an objective substance, to various applications such as a variety of filters and catalysts that utilizes the considerably large surface area of the porous body.

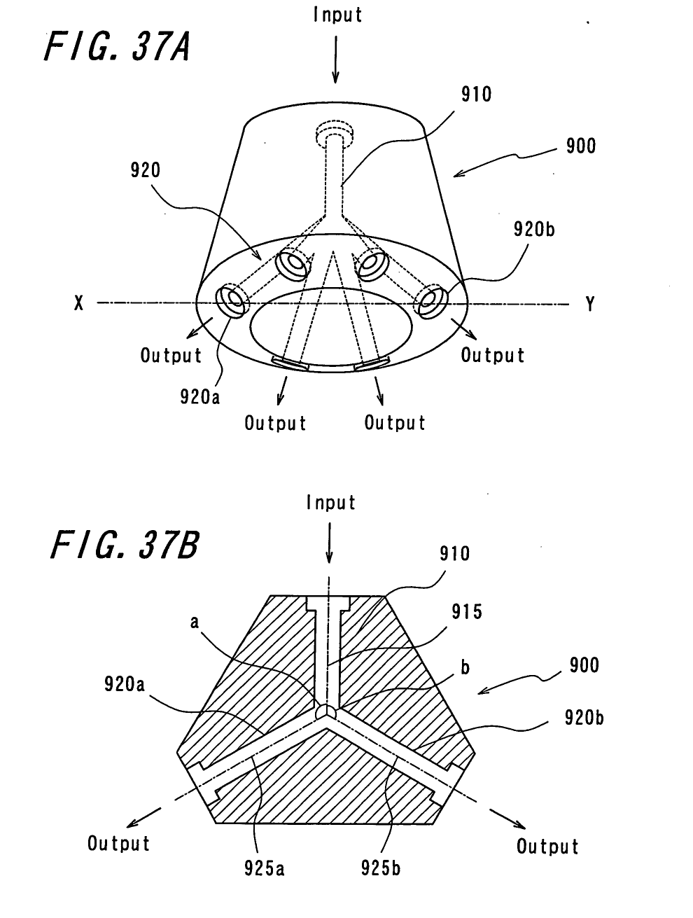

FIG. 37A is a perspective view of a connector used in an immobilization apparatus with multiple capillaries according to the present invention, and FIG. 37B is a sectional view showing the connector shown in FIG. 37A, which is taken along the X-Y line. It is preferred that a plastic having high drug resistance and high mechanical strength and capable of micromachining, for example, a fluorine-based resin such as CTFE should be used as a material for the connector.

As shown in FIG. 37A, a connector 900 has one input tube 910 and six output tubes 920. As shown in FIG. 37B, output tubes 920a and 920b have major axes 925a and 925b that form the same angle (i.e., angle a=angle b) relative to a major axis 915 of the input tube 910. If this connector is used to branch a solution, the unevenness of a flow rate (i.e., the quantity of flow) caused by branched tubing can be avoided. In addition, the solution can be fed uniformly to each capillary, and a more uniform microstructure can be created.

FIG. 38A is a graph showing the relationship between current and voltage of a solution during electrospraying, FIG. 38B is a graph showing the time course of voltage when voltage applied to a solution is varied at a predetermined period, and FIG. 38C is a graph showing the time course of current running in a solution when voltage is varied as illustrated in FIG. 38B.

As shown in FIG. 38A, in the state where the solution is being normally electrostatically sprayed during electrospraying (i.e., the state of electrospray), current linearly increases with increase in voltage as represented by a solid line. On the other hand, in the state where the solution is not being normally electrostatically sprayed and gas discharge (corona discharge) is taking place during electrospraying (i.e., the state of gas discharge), current logarithmically increases with increase in voltage as represented by a dotted line. However, the difference in the value of current between both states is slight and the discrimination between the two during spraying is difficult. It was especially difficult to discriminate the two at applied voltage around a point of intersection of the solid line and the dotted line because almost the same values of current are shown. Therefore, there has heretofore been no other choice but an approach where sprayed droplets are observed with a microscope, and inconvenience has appeared. For controlling a microstructure in a film thickness of the order of a nanometer, the concentration of a solution, the molecular weight of a sample, spray duration need to be adjusted with accuracy according to the type of the sample. That is, if there occurs the state where gas discharge takes place and fine droplets cannot be discharged, it is required that the time of the state is subtracted from the spray duration. However, the adjustment of the spray duration in consideration of such a state of spray could not be done. The present inventors have found from experiments that periodic minute variations (approximately 0.1 to 1 Hz) given to applied voltage as shown in FIG. 38B periodically changes the current of the solution in the state of gas discharge and hardly changes the current in the state of electrospray as shown in FIG. 38C, and the use of this phenomenon allows accurate discrimination between both states. For example, this discrimination allows the recognition that normal spray cannot be performed due to clogging in a nozzle of a capillary, clogging in tubing for solution supply, or the failure of a pump. Thus, it is preferred that the immobilization apparatus according to the present invention should be provided with an ammeter, a voltmeter, and a voltage controller for giving, to a power source, control signals that minutely alter voltage, to adjust spray duration more accurately. The ESD method employs a physical law where electric charges are concentrated into a site having a small radius of curvature. Thus, a solution with a shape having a small radius of curvature (Taylor Cone) is formed in the tip of the capillary, from which the solution is electrostatically sprayed. Conversely, when a solution with a shape having an appropriate radius of curvature cannot be formed in the tip of the capillary for some reason such as clogging in a nozzle and the failure of a pump, electrostatic spray does not occur even in the state where voltage is applied to the solution. The discrimination between the two by monitoring the value of current with voltage varied as described above allows the recognition of whether or not electrostatic spray is normally performed, that is, the accurate control of spray duration (the amount of spray). Accordingly, a microstructure having a desired film thickness can be created.

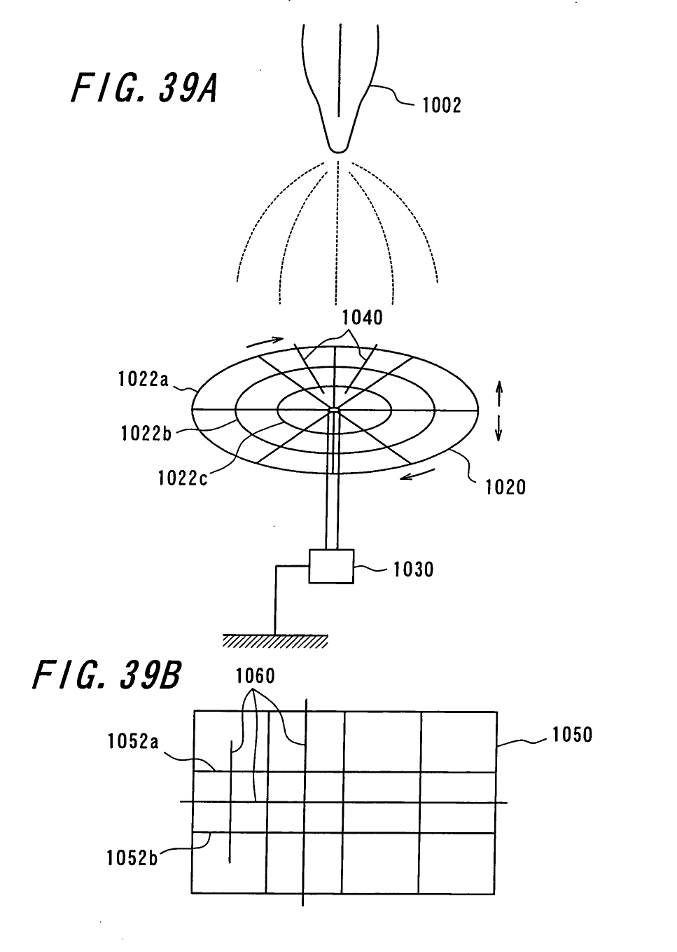

FIG. 39A is a block diagram showing a modification example of a substrate used in the immobilization apparatus according to the present invention. As shown in the drawing, a solution electrostatically sprayed from a capillary 1002 flies toward a substrate 1020. The substrate 1020 has a spider's web-shaped mesh structure composed of conductive wires 1022a, 1022b, and 1022c. The distance between the wires is from several millimeters to several tens of cm. The substrate 1020 is rotated by a rotator 1030 about the rotator 1030. Moreover, during rotation, the substrate 1020 is moved up and down as a seesaw with the center as an axis. The sprayed solution is dried during flight to form a nanofiber. The formed nanofiber 1040 is immobilized with its longitudinal direction extending radially from the center so as to bridge the wires 1022a, 1022b, and 1022c. The present inventors have found from experiments that when the nanofiber is immobilized using such a reticular substrate, the fiber is highly oriented and therefore, the degree of crystallization is rendered high. That is, the present inventors have found that a molecule within the fiber is highly oriented in the longitudinal direction of the fiber. The present inventors have also found from experiments that when this mesh substrate is rotated and further swung up and down, the orientation and the degree of crystallization are enhanced. FIG. 39B shows an alternative modification example of the substrate. A fiber 1060 is immobilized so as to bridge grounded conductive wires 1052a and 1052b on a mesh substrate 1050. As with the substrate shown in FIG. 39A, the nanofiber is highly oriented and the degree of crystallization is enhanced.

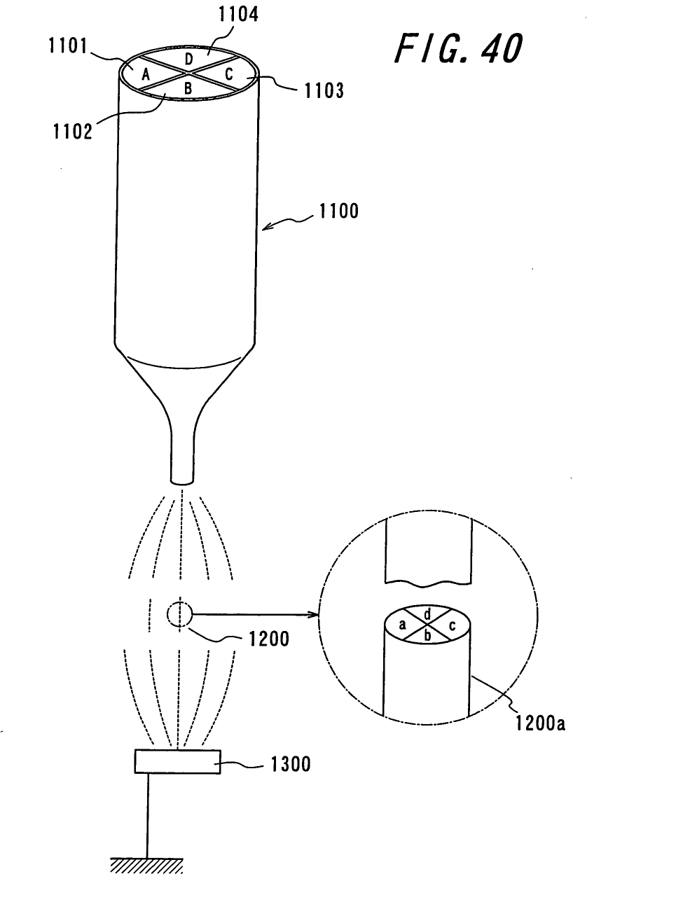

FIG. 40 is a block diagram showing a modification example of a capillary used in the immobilization apparatus according to the present invention. As shown in the drawing, a capillary 1100 comprises four cells 1101, 1102, 1103, and 1104, each of which is respectively supplied with different solutions A, B, C, and D. Voltage is applied to each of the solutions via an electrode (not shown) or a conductive partition plate dividing the cells to perform electrostatic spray. The sprayed solution is almost dried during flight toward a substrate 1300 to form a nanofiber 1200 which is eventually immobilized in the grounded substrate 1300. The use of the capillary provided with such divided cells (two or more) allows the formation of composite yarn containing each region of a component a for the solution A, a component b for the solution B, a component c for the solution C, and a component d for the solution D, as in a nanofiber 1200a shown in the enlarged view. By adjusting each component, it is also possible to create, for example, a water-repellent fiber with high strength that adsorb microorganisms therein and removes chemicals.

Although the principle of the present invention has been described herein with reference to various embodiments, it should be noted that modifications and changes can be made to the apparatus, the method, and the production method in these embodiments.

For example, in the above-described Examples, a microstructure (thin film) is formed by using invertase and lactalbumin as a protein as an objective substance and using PEG and PAA as a linear polymer suitable for forming a fiber. However, the present invention can immobilize various objective substances other than these and produce a microstructure.

Available objective substances are exemplified by polysaccharides such as chitin, chitosan, and cellulose or low molecular organic compounds for EL (e.g., an aluminum complex with quinolinol as a ligand) and high molecular organic compounds for EL (e.g., polyvinylcarbazole). Any of these organic compounds for EL can be immobilized in a desired film thickness with their functional activity (electroluminescent property) maintained. Moreover, in the present invention, the uniform distribution of such a low or high molecular compound for EL is attempted, so that a film having a uniform property can be created. In addition, light can be prevented from scattering, to increase the amount of light emission of the created film.

Concrete examples of the objective substance that can be used include low molecular compounds such as a cyclopentadiene derivative, tetraphenylbutadiene, an oxadiazole derivative (EM2), a pyrazoquinoline derivative (PZ10), a distyrylarylene derivative (DPVBi), triphenyldiamine (TPD), a perinone derivative (P1), an oligothiophene derivative (BMA-3T), a perylene derivative (tBu-PTC), Alq₃, Znq₂, Beq₂, Zn(ODZ)₂, and A1(ODZ)₃.

High molecular compounds can also be used as the objective substance, which include polyparaphenylenevinylene derivatives such as PPV and CN-PPV, polythiophene derivatives such as PAT and PCHMT, polyparaphenylene derivatives such as PPP and FP-PPP, polysilane derivatives such as PMPS and PPS, polyacetylene derivatives such as PAPA and PDPA, and the other varieties of derivatives such as PVK and PPD. Any of these objective substances is immobilized as a thin film and can thereby be utilized as an organic EL element.

In addition, a polymer mixed with for example, any of cyclohexanecarboxylic acid phenyl ester-based phenylcyclohexane-based compounds, phenylpyrimidine-based compounds, 4[4-n-decyloxy benzylideneamino]2-methylbutyl cinnamate (DOBAMBC), Schiff (azomethine)-based compounds, azoxy-based compound, cyanobiphenyl-based compounds, phenyldioxane-based compounds, tolane-based compounds, and steroid-based compounds is immobilized as a thin film and can thereby be used as a liquid crystal element.

An available solvent for dissolving and dispersing the objective substance includes water as well as a variety of organic and inorganic solvents according to the property of the objective substance.

For example, any of inorganic solvents such as carbon disulfide, hydrocarbon-based solvents such as hexane and benzene, halogen compound solvents such as chloroform and bromobenzene, alcohol/phenol-based solvents such as methanol, ethanol, propanol, and phenol, ether-based solvents such as diethyl ether and tetrahydrofurane, acid and its derivative-based solvents such as acetic acid and dimethylformamide, nitrile-based solvents such as acetonitrile and benzonitrile, nitro compound and amine-based solvents such as nitrobenzene and pyridine, and sulfur compound-based solvents such as dimethylsulfoxide may be used as the solvent according the objective substance used.

Electric conductivity for a variety of solvents is preferably 10 mS/cm or less in order to efficiently yield electric field concentration.

Although a single objective substance is immobilized in the above-described Examples, it is also possible to form a hybrid-type microstructure (such as a thin film) consisting of several objective substances by electrostatically spraying a solution where several objective substances are dissolved or by respectively electrostatically spraying, from separate capillaries, several prepared solution where different objective substances are dissolved.

When a large area is electrostatically sprayed, the capillary is installed in a shifter with a single or double or more axes. In this case, it is possible to uniformly spray the large area of an object to be coated.

1. An immobilization method, comprising the steps of:
carrying out electrospray such that a solution containing at least one objective substance is supplied into a capillary and an electric voltage is then applied on the solution to allow electrostatic atomization thereof, and
carrying out immobilization such that the objective substance in the solution atomized in the step of carrying out the electrospray is immobilized on an object, which is to be coated and has an arbitrary shape, in a dried state by an electrostatic force while retaining functionality and/or activity of the objective substance to form a dried microstructure having a thickness on the order of nanometers.

2. The immobilization method as described in claim 1, further comprising the step of, before the step of carrying out electrospray, adjusting the average particle size of the objective substance contained in the solution.

3. The immobilization method as described in claim 1, wherein, before the step of carrying out electrospray, the solution is prepared by dissolving or dispersing an objective substance having a predetermined average molecular weight.

4. The immobilization method as described in claim 1, wherein
the electrospray step also comprises the steps of previously defining, on the basis of a kind of the solution, an analytical curve representing a relationship between a duration of electrostatic atomization and a thickness of the microstructure, using the analytical curve corresponding to the kind of the solution used to define the duration of the electrostatic atomization depending on a desired film thickness.

5. The immobilization method as described in claim 1, wherein
the object to be coated is one of a substrate having at least slight electrical conductivity, a film, a polygonal column-shaped member, a cylindrical member, a fine particle, a globular substance, or a porous body.

6. The immobilization method as described in claim 1, wherein
the object to be coated is insulative, and
the immobilization method further comprises the step of supplying ionic wind generated by means of an ion generator to a microstructure on the object to be coated to remove electricity.

7. The immobilization method as described in claim 1, wherein
the electrospray step uses as the objective substance a substance suitable for the formation of a fiber, and the objective substance is then electrostatically atomized to form a fibrous microstructure, and
the immobilization step immobilizes the fibrous microstructure on the object to be coated.

8. The immobilization method as described in claim 7, wherein
the material suitable for the formation of the fiber is a linear polymer.

9. The immobilization method as described in claim 7, wherein
the object to be coated is a polygonal column-shaped member or a cylindrical member, and
a step of winding up the fibrous microstructure on the surface of the object to be coated by rotating the object to be coated is also comprised.

10. The immobilization method as described in claim 1, wherein
the electrospray step also comprises
at least one of the steps of shifting the capillary, changing the direction of spray by arbitrarily changing the angle of the capillary, or shifting the object to be coated.

11. The immobilization method as described in claim 1, wherein
the electrospray step also comprises the step of oscillating the capillary.

12. The immobilization method as described in claim 1, wherein
the electrostatic atomization in the electrospray step is carried out using a capillary having a tip portion of 100 μm or more in inner diameter.

13. The immobilization method as described in claim 1, wherein
the electrospray step comprises the steps of performing the electrostatic atomization while providing a minute range of a periodic change in voltage applied on the solution to distinguish an electrostatic atomization state and a gas discharging state, and monitors an amount of change in current value of the solution using an ampere meter.

14. The immobilization method as described in claim 1, wherein
the electrospray step comprises any of the steps of adjusting the pressure of the solution when the solution is supplied to the capillary, adjusting the flow rate of the solution, or adjusting so as to establish a constant relational expression between the pressure and the flow rate of the solution.

15. The immobilization method as described in claim 1, wherein
the electrospray step comprises any of the steps of adjusting a voltage at constant when the voltage is applied on the solution, adjusting the voltage so that a current passing through the solution becomes constant, or adjusting the voltage to establish a constant relationship between the voltage and the current.

16. The immobilization method as described in claim 1, wherein
the raw material of the capillary is any of a metal, glass, silicon, or synthesized polymer material.

17. The immobilization method as described in claim 1, wherein
when multiple capillaries are provided, the electrospray step also comprises the step of adjusting each of a voltage or a current supplied to the solution contained in each of the capillaries to an optimal value.

18. The immobilization method as described in claim 1, wherein
multiple capillaries are provided, and the electrospray step comprises the step of dividing the solution to supply the solution to the multiple capillaries by use of a connector having the same number of output tubes as that of the capillaries per a single input tube, where each of the output tubes has its major axis inclined at the same angle as that of the major axis of the input tube.

19. The immobilization method as described in claim 1, wherein
multiple capillaries are provided and each of the capillaries is connected with multiple tubes having their own valves, and
the electrospray step comprises the step of individually opening or closing the valve to concentrate a pressure force of the solution to at least only one of the capillaries so that degassing and/or dipping can be easily performed.

20. The immobilization method as described in claim 1, wherein
the voltage applied on the solution is intermittently supplied.

21. The immobilization method as described in claim 1, wherein
a portion to be touched with the solution and/or the electrostatically atomized objective substance is tolerative with respect to the solution and/or the objective substance.

22. The immobilization method as described in claim 1, further comprising the step of:
using at least one of a collimator electrode, means for supplying an ion flow, or means for supplying a pressure air, to converge the objective substance electrostatically atomized in the electrospray step.

23. The immobilization method as described in claim 1, further comprising the step of:
surrounding a space in which at least both the electrostatic atomization and the immobilization is carried out and then supplying inert gas and/or clean dry air into the case.

24. The immobilization method as described in claim 23, further comprising the step of:
carrying out pressure reduction or evacuation in the inside of the case.

25. An immobilization apparatus, comprising:
means for electrospraying, by which a solution containing at least one objective substance is supplied into a capillary and an electric voltage is then applied on the solution to allow electrostatic atomization thereof;
means for supporting an object, which is to be coated and has an arbitrary shape, on which the objective substance is immobilized in a dried state by an electrostatic force while retaining functionality and activity of the objective substance to form a dried microstructure having a thickness on the order of nanometers; and
at least one of means for shifting the capillary, means for changing the angle of the capillary to an arbitrary angle, or means for shifting the object to be coated.

26. The immobilization apparatus as described in claim 25, wherein
the means for electrospraying performs electrostatic atomization while providing a minute range of a periodic change in voltage applied on the solution, and
the immobilization apparatus further includes means for measuring a current, which monitors an amount of change in current value of the solution.

27. A method of manufacturing a microstructure having a thickness on the order of nanometers, comprising the steps of:
carrying out electrospray by which a solution containing at least one objective substance suitable for the formation of a fiber is supplied into a capillary and an electric voltage is then applied on the solution to allow electrostatic atomization thereof; and
electrostatically immobilizing the objective substance in the solution atomized by the electrospray step on an object, which is to be coated and has an arbitrary shape, in the dry state while retaining the functionality and/or activity of the objective substance to form a dried fibrous microstructure having a thickness on the order of nanometers.
